(19) United States
(12) Patent Application Publication
(10) Pub. No.: US 2016/0253047 A1
(43) Pub. Date: Sep. 1, 2016

(54) METHOD FOR OPERATING ELECTRONIC DEVICE, ELECTRONIC DEVICE, AND STORAGE MEDIUM

(71) Applicant: Samsung Electronics Co., Ltd., Gyeonggi-do (KR)

(72) Inventors: Hyung-Min KIM, Seoul (KR); Soo-Wan Park, Gyeonggi-do (KR); Chang-Mo Yang, Gyeonggi-do (KR); Jee-Yeun Wang, Seoul (KR); Seung-Ho Shin, Gyeonggi-do (KR); Young-Min Kwak, Gyeonggi-do (KR); Joon-Seok Lee, Gyeonggi-do (KR); Kang-Sik Choi, Gyeonggi-do (KR); Chul-Hwan Hyun, Gyeonggi-do (KR)

(73) Assignee: Samsung Electronics Co., Ltd.

(21) Appl. No.: 15/056,459

(22) Filed: Feb. 29, 2016

(30) Foreign Application Priority Data
Feb. 27, 2015 (KR) 10-2015-0028398

(51) Int. Cl. G06F 3/0481; G06F 3/0488; G06F 3/0484

(52) U.S. Cl. CPC G06F 3/0481; G06F 3/04845; G06F 3/0488

(57) ABSTRACT

A method for operating a user interface of an electronic device is provided. The method includes displaying at least one fluid graphic element on a display of the electronic device, determining whether a preset second condition associated with the at least one fluid graphic element is satisfied, and performing a preset function of the electronic device if the second condition is satisfied.

### PRIORITY

This application claims priority under 35 U.S.C. §119(a) to Korean Patent Application Serial No. 10-2015-0028398, filed in the Korean Intellectual Property Office on Feb. 27, 2015, the entire content of which is incorporated herein by reference.

### BACKGROUND

1. Field of the Disclosure

The present disclosure generally relates to an electronic device and method for providing a user interface (UI).

2. Description of the Related Art

Recently, electronic devices such as smart phones, tablet personal computers (PCs), and the like have provided various and intuitive user interfaces (UIs) to users.

Visual simulation has been widely used in movies, dramas, games, and so forth. With the recent improvement in capabilities of electronic devices, the electronic devices have provided UIs using visual simulation.

### SUMMARY

Various aspects of the present disclosure provide a method for an intuitive UI together with natural appearing graphic elements.

According to an aspect of the present disclosure, there is provided a method for operating an electronic device, the method including displaying at least one fluid graphic element on a display of the electronic device, determining whether a preset second condition associated with the at least one fluid graphic element is satisfied, and performing a preset function of the electronic device if the second condition is satisfied.

According to another aspect of the present disclosure, there is provided an electronic device including a display configured to display a screen, and a processor configured to display at least one fluid graphic element on the display, to determine whether a preset second condition associated with the at least one fluid graphic element is satisfied, and to perform a preset function of the electronic device if the processor determines that the second condition is satisfied.

### BRIEF DESCRIPTION OF THE DRAWINGS

The above and other aspects, features and advantages of certain embodiments of the present invention will be more apparent from the following description taken in conjunction with the accompanying drawings, in which:

FIG. 1 is a block diagram of an electronic device in a network environment according to various embodiments of the present disclosure;

FIG. 2 is a block diagram of an electronic device according to various embodiments of the present disclosure;

FIG. 3 is a block diagram of a programming module according to various embodiments of the present disclosure;

FIG. 4 is a flowchart illustrating a method for operating an electronic device according to various embodiments of the present disclosure;

FIG. 5 is a flowchart illustrating a method for operating an electronic device according to various embodiments of the present disclosure;

FIGS. 6A to 6C are views for describing a method for operating an electronic device according to various embodiments of the present disclosure;

FIG. 7 is a view for describing a hovering input;

FIGS. 8A to 8C are views for describing a method for operating an electronic device according to various embodiments of the present disclosure;

FIGS. 9A to 9C are views for describing a method for operating an electronic device according to various embodiments of the present disclosure;

FIGS. 10A to 10C are views for describing a method for operating an electronic device according to various embodiments of the present disclosure;

FIG. 11 is a flowchart for describing a method for operating an electronic device according to various embodiments of the present disclosure;

FIGS. 12A to 12E are views for describing a method for operating an electronic device according to various embodiments of the present disclosure;

FIGS. 13A to 13C are views for describing a method for operating an electronic device according to various embodiments of the present disclosure;

FIG. 14 is a flowchart illustrating a method for operating an electronic device according to various embodiments of the present disclosure;

FIG. 15 is a view for describing a method for determining a position of an electronic device;

FIG. 16A to 16C are views for describing a method for operating an electronic device according to various embodiments of the present disclosure; and

FIG. 17A to 17C are views for describing a method for operating an electronic device according to various embodiments of the present disclosure.

### DETAILED DESCRIPTION

Hereinafter, various embodiments of the present disclosure will be disclosed with reference to the accompanying drawings. However, the description is not limited to the particular forms disclosed herein, and it should be construed as including various modifications, equivalents, and/or alternatives according to the embodiments of the present disclosure. In regards to the description of the drawings, like reference numerals refer to like elements.

In the present disclosure, the expressions “having,” “may have,” “comprising,” or “may comprise” refer to the existence of a corresponding characteristic (such as a numerical value, element, function, operation, or component) and do not exclude the existence of additional characteristics.

In the present disclosure, the expressions “A or B,” “A/B,” “at least one of A or/and B,” or “one or more of A or/and B” include all possible combinations of listed items. For example, “A or B,” “at least one of A and B,” or “one or more of A or B” may refer to the entire of (1) including at least one A, (2) including at least one B, or (3) including both at least one A and at least one B.

The expressions “first,” “second,” “primarily,” or “secondary,” used in various embodiments of the present disclosure may represent various elements regardless of order and/or importance and do not limit corresponding elements. The expressions may be used for distinguishing one element from another element. For example, a first user device and a second user device may represent different user devices regardless of order or importance. For example, a first element may be referred to as a second element without departing from the scope of the present disclosure, and similarly, a second element may be referred to as a first element.

When it is described that an element (such as a first element) is “operatively or communicatively coupled” to or “connected” to another element (such as a second element), the element may be directly connected to the other element or may be connected to the other element through a third element. However, when it is described that an element (such as a first element) is “directly connected” or “directly coupled” to another element (such as a second element), it means there is no intermediate element (such as a third element) between the element and the other element.

The expression “configured to (or set)” used in the present disclosure may be used interchangeably with, for example, “suitable for,” “having the capacity to,” “designed to,” “adapted to,” “made to,” or “capable of” according to the situation. The term “configured to (or set)” does not always mean only “specifically designed to” by hardware. Alternatively, in some situation, an expression “apparatus configured to” may mean the apparatus “can” operate together with another apparatus or component. For example, the phrase “a processor configured (or set) to perform A, B, and C” may be a general-purpose processor (such as a CPU or an application processor) that can perform a corresponding operation by executing at least one software program stored in a processor (such as an embedded processor) for performing a corresponding operation or in a memory device.

Terms defined in the present disclosure are used for only describing a specific embodiment and do not limit the scope of other embodiments. When used in a description of the present disclosure and the appended claims, a singular form may include a plurality of forms unless it is explicitly represented differently. All terms including technical terms and scientific terms used in the present disclosure have the same meanings as generally understood by a person of ordinary skill in the relevant art. Generally used terms defined in a dictionary have the same meaning as, or a meaning similar to, that of related technology and do not have an ideal or excessively formal meaning unless explicitly defined. In some case, terms defined in the present disclosure cannot be analyzed to exclude the present exemplary embodiments.

An electronic device according to various embodiments of the present disclosure may be a device including a communication function. For example, the electronic device may include at least one of a smart phone, a tablet personal computer (PC), a mobile phone, a video phone, an electronic book (e-book) reader, a desktop PC, a laptop PC, a netbook computer, a personal digital assistant (PDA), a portable multimedia player (PMP), an MP3 player, mobile medical equipment, a camera, and a wearable device. According to an embodiment of the present disclosure, a wearable device may include at least one of an accessory type (e.g., a watch, a ring, a bracelet, an anklet, a necklace, glasses, a contact lens, or head-mounted device (HMD)), a fabric or clothing-integrated type (e.g., an electronic cloth), a body-attached type (e.g., a skin pad or tattoo), and a body-implanted type (e.g., an implantable circuit).

According to an embodiment of the present disclosure, the electronic device may be a home appliance. The home appliance may include, for example, at least one of a television (TV), a digital video disk (DVD) player, audio equipment, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ or PlayStation™), an electronic dictionary, an electronic key, a camcorder, and an electronic frame.

According to another embodiment of the present disclosure, the electronic device may include at least one of various medical equipment (e.g., various portable medical measurement systems, such as a blood sugar measurement device, a heartbeat measurement device, a blood pressure measurement device, or a body temperature measurement device, magnetic resonance angiography (MRA), magnetic resonance imaging (MRI), computed tomography (CT), an imaging device, or an ultrasonic device), a navigation system, a global navigation satellite system (GNSS), an event data recorder (EDR), a flight data recorder (FDR), a vehicle infotainment device, electronic equipment for ships (e.g., navigation system and gyro compass for ships), avionics, a security device, a vehicle head unit, an industrial or home robot, an automatic teller machine (ATM), a point of sales (POS) terminal, Internet of Things (IoT) device (e.g., electric light bulbs, various sensors, electricity or gas meters, sprinkler devices, fire alarm devices, thermostats, streetlights, toasters, exercise machines, hot-water tanks, heaters, boilers, etc.).

According to an embodiment of the present disclosure, the electronic device may include a part of a furniture or building/structure, an electronic board, an electronic signature receiving device, a projector, and various measuring instruments (e.g., a water, electricity, gas, or electric wave measuring device). The electronic device according to various embodiments of the present disclosure may be one of the above-listed devices or a combination thereof. The electronic device may be a flexible device. It will be obvious to those of ordinary skill in the art that the electronic device is not limited to the above-listed devices and may include new electronic devices according to technology developments.

Hereinafter, an electronic device according to various embodiments of the present disclosure will be described with reference to the accompanying drawings. The term “user” used in various embodiments of the present disclosure may refer to a person who uses the electronic device or a device using the electronic device (e.g., an artificial intelligence electronic device).

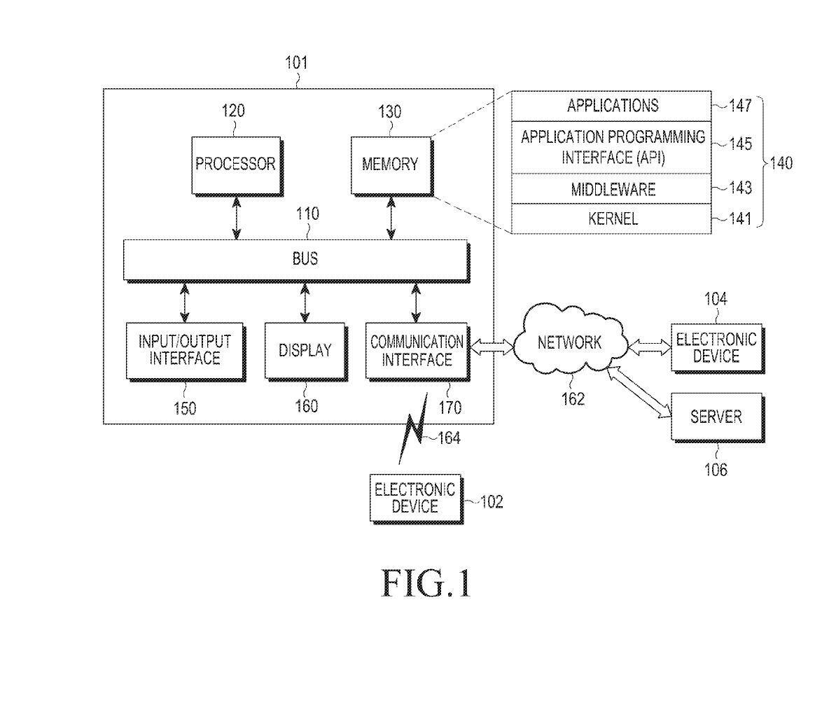

FIG. 1 is a block diagram of an electronic device in a network environment according to various embodiments of the present disclosure;

Referring to FIG. 1, the electronic device 101 includes a bus 110, a processor 120, a memory 130, an I/O interface 150, a display 160, and a communication interface 170. According to some embodiments, the electronic device 101 may omit at least one of the foregoing elements or may further include other elements.

The bus 110 may include a circuit for interconnecting the elements 120, 130, 150, 160 and 170 described above and for allowing communication (e.g., a control message and/or data) between the elements 120, 130, 150, 160 and 170.

The processor 120 may include one or more of a Central Processing Unit (CPU), an Application Processor (AP), and a Communication Processor (CP). The processor 120 performs operations or data processing for control and/or communication of, for example, at least one other element of the electronic device 101. The processor 120 may be referred to as a controller, may include the controller as a part thereof, or may form the controller.

The memory 130 may include a volatile and/or nonvolatile memory. The memory 130 may store, for example, commands or data associated with at least one other elements of the electronic device 101. According to an embodiment of the present disclosure, the memory 130 may store software and/or a program 140. The program 140 includes, for example, a kernel 141, middleware 143, an Application Programming Interface (API) 145, and/or an application program (or an application) 147. At least some of the kernel 141, the middleware 143, and the API 145 may be referred to as an Operating System (OS).

The kernel 141 controls or manages, for example, system resources (e.g., the bus 110, the processor 120, or the memory 130) used to execute an operation or a function implemented in other programs (e.g., the middleware 143, the API 145, or the application program 147). The kernel 141 provides an interface through which the middleware 143, the API 145, or the application program 147 accesses separate components of the electronic device 101 to control or manage the system resources.

The middleware 143 may work as an intermediary for allowing, for example, the API 145 or the application program 147 to exchange data in communication with the kernel 141.

In regard to one or more task requests received from the application program 147, the middleware 143 may process the tasks according to priorities. For example, the middleware 143 may assign priorities for using a system resource (e.g., the bus 110, the processor 120, or the memory 130) of the electronic device 101 to at least one of the application programs 147. The middleware 143 may perform scheduling or load balancing with respect to the one or more task requests by processing the one or more task requests according to a priority assigned to the at least one application program 147.

The API 145 is an interface used for the application 147 to control a function provided by the kernel 141 or the middleware 143, and may include, for example, at least one interface or function (e.g., a command) for file control, window control, image processing or character control.

The I/O interface 150 serves as an interface for delivering a command or data input from a user or another external device to other element(s) 110 through 170 of the electronic device 101. The I/O interface 150 may also output a command or data received from other element(s) 110 through 170 of the electronic device 101 to a user or another external device.

The display 160 may include, for example, a Liquid Crystal Display (LCD), a Light Emitting Diode (LED) display, an Organic Light Emitting Diode (OLED) display, a MicroElectroMechanical System (MEMS) display, or an electronic paper display. The display 160 may display various contents (e.g., a text, an image, video, an icon, or a symbol) to users. The display 160 may include a touch screen, and receive a touch, a gesture, proximity, or a hovering input, for example, by using an electronic pen or a part of a body of a user.

The communication interface 170 sets up communication, for example, between the electronic device 101 and an external device (e.g., a first external electronic device 102, a second external electronic device 104, or a server 106). For example, the communication interface 170 is connected to a network 162 through wireless or wired communication to communicate with the external device 104 or the server 106. The communication interface 170 may include a communication processor (CP) that may form one of a plurality of modules of the communication interface 170. In an embodiment of the present disclosure, the CP may be included in the processor 120.

The wireless communication may use, as a cellular communication protocol, for example, at least one of long term evolution (LTE), LTE-advanced (LTE-A), code division multiple access (CDMA), wideband CDMA (WCDMA), a universal mobile telecommunication system (UMTS), wireless broadband (WiBro), or global system for mobile communications (GSM). The wireless communication may include, for example, short-range communication 164. The short-range communication 164 may include, for example, at least one of wireless-fidelity (Wi-Fi), Bluetooth, near field communication (NFC), and a global navigation satellite system (GNSS). The GNSS may include at least one of a global positioning system (GPS), a Glonass system, a Beidou navigation satellite system (Beidou), and Galileo, the European global satellite-based navigation system, depending on a use area or bandwidth. Hereinafter, the term GPS may be used interchangeably with GNSS. The wired communication may include, for example, at least one of a universal serial bus (USB), a high definition multimedia interface (HDMI), a recommended standard (RS)-232, and a plain old telephone service (POTS). The network 162 may include a telecommunications network, for example, at least one of a computer network (e.g., a local area network (LAN) or a wide area network (WAN)), the Internet, and a telephone network.

Each of the first external electronic device 102 and the second external electronic device 104 may be a device of the same type as or a different type than the electronic device 101. According to an embodiment of the present disclosure, the server 106 may include a group of one or more servers. All or some of operations performed in the electronic device 101 may be performed in another electronic device or a plurality of electronic devices (e.g., the electronic devices 102 and 104 or the server 106). When the electronic device 101 has to perform a function or a service automatically or at the request of a user, the electronic device 101 may request another device 102, 104 or the server 106 to perform at least some functions associated with the function or the service instead of, or in addition to, executing the function or the service. The another electronic device 102, 104 or the server 106 may perform the requested function or an additional function and deliver the result to the electronic device 101. The electronic device 101 provides the received result or provides the requested function or service by processing the received result. To this end, for example, cloud computing, distributed computing, or client-server computing may be used.

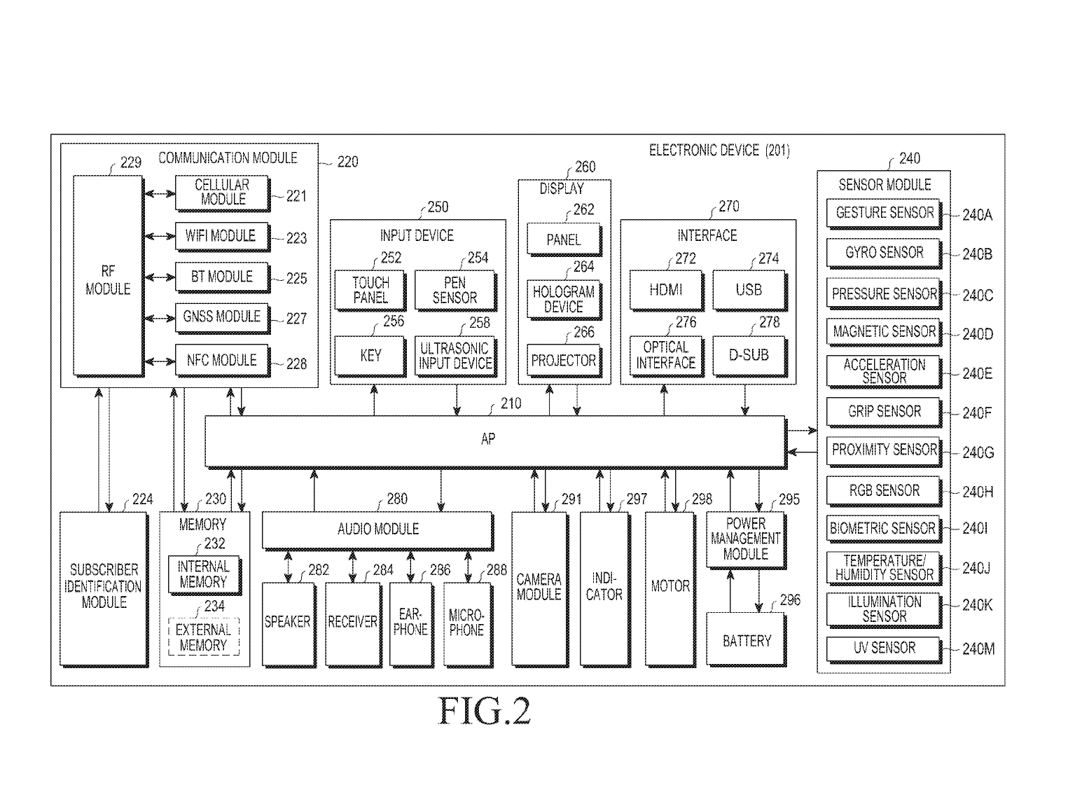

FIG. 2 is a block diagram of an electronic device 201 according to various embodiments of the present disclosure.

Referring to FIG. 2, an electronic device 201 may form the entire electronic device 101 illustrated in FIG. 1 or a part of the electronic device 101 illustrated in FIG. 1. The electronic device 201 includes one or more application processors (APs) 210, a communication module 220, a memory 230, a sensor module 240, an input module 250, a display 260, an interface 270, an audio module 280, a camera module 291, a power management module 295, a battery 296, an indicator 297, and a motor 298.

The processor 210 controls multiple hardware or software components connected to the processor 210 by driving an operating system (OS) or an application program, and performs processing and operations with respect to various data including multimedia data. The processor 210 may be implemented with, for example, a system on chip (SoC). According to an embodiment of the present disclosure, the processor 210 may further include a graphic processing unit (GPU) and/or an image signal processor. The processor 210 may include at least some of the elements illustrated in FIG. 2 (e.g., a cellular module 221). The processor 210 loads a command or data received from at least one of other elements (e.g., a non-volatile memory) into a volatile memory and processes the command or data and stores various data in the non-volatile memory.

The communication module 220 may have a configuration that is the same as or similar to the communication interface 170 illustrated in FIG. 1. The communication module 220 includes, for example, the cellular module 221, a WiFi module 223, a Bluetooth (BT) module 225, a GNSS module 227 (e.g., a GPS module, a Glonass module, a Beidou module, or a Galileo module), a near field communication (NFC) module 228, and a radio frequency (RF) module 229.

The cellular module 221 may provide, for example, a voice call, a video call, a text messaging service, or an Internet access service over a communication network. According to an embodiment of the present disclosure, the cellular module 221 may identify and authenticate the electronic device 201 in a communication network by using a subscriber identification module (e.g., the SIM module 224). The cellular module 221 performs at least one function that may be provided by the processor 210. The cellular module 221 may include a communication processor (CP).

Each of the WiFi module 223, the BT module 225, the GNSS module 227, and the NFC module 228 may include a processor for processing data transmitted to, and received by, a corresponding module. According to an embodiment of the present disclosure, at least part (e.g., two or more) of the cellular module 221, the WiFi module 223, the BT module 225, the GNSS module 227, and the NFC module 228 may be included in one Integrated Chip (IC) or IC package.

The RF module 229 may transmit and receive a communication signal (e.g., an RF signal). The RF module 229 may include a transceiver, a power amp module (PAM), a frequency filter, a low noise amplifier (LNA), or an antenna. According to an embodiment of the present disclosure, at least one of the cellular module 221, the WiFi module 223, the BT module 225, the GNSS module 227, and the NFC module 228 may transmit and receive an RF signal through a separate RF module.

The SIM module 224 may include a card including an SIM and/or an embedded SIM, and may include unique identification information (e.g., an integrated circuit card identifier (ICCID) or subscriber information (e.g., an international mobile subscriber identity (IMSI)).

The memory 230 (e.g., the memory 130) may include an internal memory 232 and/or an external memory 234. The internal memory 232 may include at least one of a volatile memory (e.g., dynamic random access memory (DRAM), static RAM (SRAM), synchronous dynamic RAM (SDRAM), and a non-volatile memory (e.g., one time programmable read only memory (OTPROM), programmable ROM (PROM), erasable and programmable ROM (EPROM), electrically erasable and programmable ROM (EEPROM), mask ROM, flash ROM, NAND flash memory, or NOR flash memory), and a solid state drive (SSD).

The external memory 234 may further include a flash drive, for example, compact flash (CF), secure digital (SD), micro-SD, mini-SD, extreme Digital (xD), a MultiMedia Card (MMC), or a memory stick. The external memory 234 may be functionally and/or physically connected with the electronic device 201 through various interfaces.

The sensor module 240 measures a physical quantity or senses an operation state of the electronic device 201 to convert the measured or sensed information into an electric signal. The sensor module 240 may include at least one of a gesture sensor 240A, a gyro sensor 240B, a pressure sensor 240C, a magnetic sensor 240D, an acceleration sensor 240E, a grip sensor 240F, a proximity sensor 240G, a color sensor 240H (e.g., RGB sensor), a biometric sensor 240I, a temperature/humidity sensor 240J, an illumination sensor 240K, and a ultraviolet (UV) sensor 240M. Additionally or alternatively, the sensor module 240 may include an e-nose sensor, an electromyography (EMG) sensor, an electroencephalogram (EEG) sensor, an electrocardiogram (ECG) sensor, or a fingerprint sensor. The sensor module 240 may further include a control circuit for controlling at least one sensor included therein. The electronic device 201 may further include a processor configured to control the sensor module 240 as part of or separately from the processor 210, to control the sensor module 240 during a sleep state of the processor 210.

The input module 250 may include a touch panel 252, and the input module 250 may further include at least one of a (digital) pen sensor 254, a key 256, and an ultrasonic input device 258. The touch panel 252 may use at least one of a capacitive type, a resistive type, an IR type, or an ultrasonic type. The touch panel 252 may further include a control circuit. The touch panel 252 may further include a tactile layer to provide tactile reaction to the user.

The (digital) pen sensor 254 may include an input recognition panel which is a part of the touch panel 252 or a separate recognition panel. The key 256 may also include a physical button, an optical key, or a keypad. The ultrasonic input device 258 senses ultrasonic waves generated as an input means through a microphone 288 and processes data corresponding to the sensed ultrasonic waves.

The display 260 (e.g., the display 160) includes a panel 262, a hologram 264 and a projector 266. The panel 262 may have a configuration that is the same as or similar to that of the display 160 of FIG. 1. The panel 262 may be implemented to be flexible, transparent, or wearable. The panel 262 may be configured with the touch panel 252 in one module. The hologram 264 shows a stereoscopic image in the air by using interference of light. The projector 266 displays an image onto an external screen through projection of light. The screen may be positioned inside or outside the electronic device 201. According to an embodiment of the present disclosure, the display 260 may further include a control circuit for controlling the panel 262, the hologram 264, or the projector 266.

The interface 270 includes a high-definition multimedia interface (HDMI) 272, a universal serial bus (USB) 274, an optical communication 276, and a D-subminiature 278. The interface 270 may be included in the communication interface 170 illustrated in FIG. 1. Additionally or alternatively, the interface 270 may include a Mobile High-Definition Link (MHL) interface, an SD/MMC interface, or an infrared data association (IrDA) interface.

The audio module 280 bi-directionally converts sound into an electric signal. At least one element of the audio module 280 may be included in the I/O interface 150 illustrated in FIG. 1. The audio module 280 processes sound information input or output through the speaker 282, the receiver 284, the earphone 286, or the microphone 288.

The camera module 291 is a device capable of capturing a still image or a moving image, and according to an embodiment of the present disclosure, may include one or more image sensors (e.g., a front sensor or a rear sensor), a lens, an image signal processor (ISP), or a flash (e.g., an LED or a xenon lamp).

The power management module 295 manages power of the electronic device 201. According to an embodiment of the present disclosure, the power management module 295 may include a Power management integrated circuit (PMIC), a charger IC, or a battery gauge. The PMIC may have a wired and/or wireless charging scheme. The wireless charging scheme includes a magnetic-resonance type, a magnetic induction type, and an electromagnetic type. For wireless charging, an additional circuit, for example, a coil loop, resonance circuit, or a rectifier may be further included. The battery gauge measures the remaining capacity of the battery 296 or the voltage, current, or temperature of the battery 296 during charging. The battery 296 may include a rechargeable battery and/or a solar battery.

The indicator 297 displays a particular state, for example, a booting state, a message state, or a charging state, of the electronic device 201 or a part thereof (e.g., the processor 210). The motor 298 converts an electric signal into mechanical vibration or generates vibration or a haptic effect. The electronic device 201 may include a processing device (e.g., a GPU) for supporting a mobile TV. The processing device for supporting the mobile TV processes media data according to a standard such as digital multimedia broadcasting (DMB), digital video broadcasting (DVB), or MediaFlo™.

Each of the foregoing elements described herein may include one or more components, and a name of the element or component may vary with a type of the electronic device 201. The electronic device according an embodiment of the present disclosure may include at least one of the foregoing elements, and some of the elements may be omitted or other elements may be further included therein. As some of the elements of the electronic device 201 are combined into one entity, thereby performing the same function as those of the elements that have not been combined.

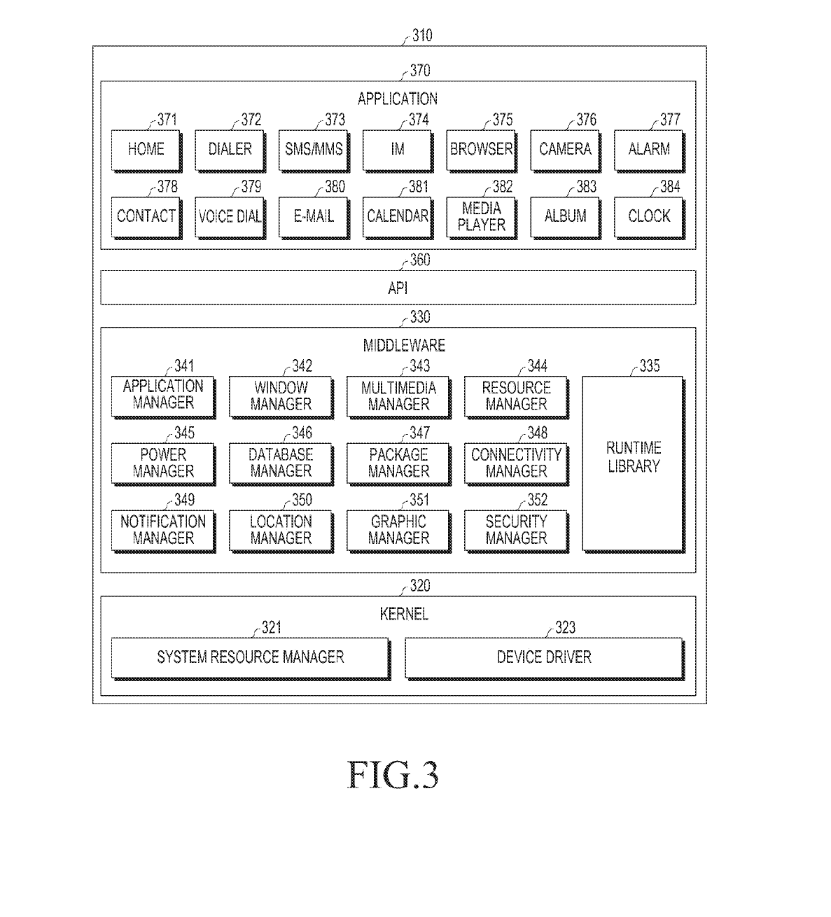

FIG. 3 is a block diagram of a programming module according to various embodiments of the present disclosure. A programming module 310 (e.g., the program 140) may include an OS for controlling resources associated with an electronic device (e.g., the electronic device 101) and/or various applications executed on the OS. The OS may include Android™, iOS, Windows™, Symbian™, Tizen™, or Bada.

The programming module 310 includes a kernel 320, a middleware 330, an application programming interface (API) 360, and/or an application 370. At least a part of the programming module 310 may be preloaded on an electronic device or may be downloaded from an external electronic device 102, 104, or the server 106.

The kernel 320 (e.g., the kernel 141) includes a system resource manager and/or a device driver 323. The system resource manager 321 may perform control, allocation, or retrieval of system resources. The system resource manager 321 may include a process management unit, a memory management unit, or a file system. The device driver 323 may include, for example, a display driver, a camera driver, a Bluetooth driver, a shared memory driver, a USB driver, a keypad driver, a WiFi driver, an audio driver, or an inter-process communication (IPC) driver.

The middleware 330 may include functions that the application 370 commonly requires or may provide various functions to the application 370 through the API 360, to allow the application 370 to efficiently use limited system resources in an electronic device. The middleware 330 (e.g., the middleware 143) includes at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses to add a new function through a programming language while the application 370 is executed. The runtime library 335 performs functions relating to an I/O, memory management, or calculation operation.

The application manager 341 manages a lifecycle of at least one application among the applications 370. The window manager 342 manages a GUI resource using a display screen. The multimedia manager 343 recognizes a format necessary for playing various media files and performs encoding or decoding on a media file by using a codec appropriate for a corresponding format. The resource manager 344 manages resources such as source code, memory, or storage space of at least one application among the applications 370.

The power manager 345 manages a battery or power in cooperation with a basic input/output system (BIOS) and provides power information necessary for operation of the electronic device. The database manager 346 performs management operation to generate, search or change a database used by at least one application among the applications 370. The package manager 347 manages the installation or update of an application distributed in a package file format.

The connectivity manager 348 manages a wireless connection such as a WiFi or Bluetooth connection. The notification manager 349 displays or notifies events such as arrival messages, appointments, and proximity alerts in a manner that is not disruptive to a user. The location manager 350 manages location information of an electronic device. The graphic manager 351 manages a graphic effect to be provided to a user or a user interface (UI) related to the user. The security manager 352 provides a general security function necessary for system security or user authentication. According to an embodiment of the present disclosure, when an electronic device (e.g., the electronic device 101) has a call function, the middleware 330 may further include a telephony manager for managing a voice or video call function of the electronic device.

The middleware 330 may include a middleware module forming a combination of various functions of the above-mentioned internal elements. The middleware 330 may provide modules specific to the OS, to provide distinctive functions. Additionally, the middleware 330 may delete some of existing elements or add new elements dynamically.

The API 360 (e.g., the API 145) may be provided as a set of API programming functions with a different configuration according to the OS. In the case of Android™ or iOS, for example, one API set may be provided by each platform, and in the case of Tizen™, two or more API sets may be provided.

The application 370 (e.g., the application program 147) includes one or more applications capable of providing a function, for example, a home application 371, a dialer application 372, a short messaging service/multimedia messaging service (SMS/MMS) application 373, an instant message (IM) application 374, a browser application 375, a camera application 376, an alarm application 377, a contact application 378, a voice dial application 379, an e-mail application 380, a calendar application 381, a media player application 382, an album application 383, a clock application 384, a health care application (e.g., an application for measuring an exercise amount or a blood sugar level), or an environment information providing application (e.g., an application for providing air pressure, humidity, or temperature information).

According to an embodiment of the present disclosure, the application 370 may include an application (hereinafter, an “information exchange application”) supporting information exchange between the electronic device 101 and an external electronic device 102 or 104. The information exchange application may include, for example, a notification relay application for transferring specific information to the external electronic device or a device management application for managing the external electronic device.

The notification relay application may include a function for transferring notification information generated in another application (e.g., an SMS/MMS application, an e-mail application, a health care application, or an environment information application) of the electronic device 101 to an external electronic device 102 or 104. The notification relay application may receive notification information from an external electronic device to provide the same to a user.

The device management application may manage (e.g., install, remove, or update) at least one function (e.g., turn on/turn off an external electronic device itself (or a part thereof) or control of brightness (or resolution) of a display, a service provided by an application operating in an external electronic device or provided by the external electronic device (e.g., a call service or a message service).

According to an embodiment of the present disclosure, the application 370 may include an application (e.g., a health care application of mobile medical equipment) designated according to an attribute of the external electronic device 102 or 104. The application 370 may include an application received from the external electronic device 102, 104 or the server 106. The application 370 may include a preloaded application or a third party application that may be downloaded from the server 106. Names of elements of the programming module 310 may vary depending on the type of OS.

According to an embodiment of the present disclosure, at least a part of the programming module 310 may be implemented by software, firmware, hardware, or a combination of at least two of them. At least a part of the programming module 310 may be implemented (e.g., executed) by a processor (e.g., the processor 210). At least a part of the programming module 310 may include a module, a program, a routine, sets of instructions, or a process for performing one or more functions.

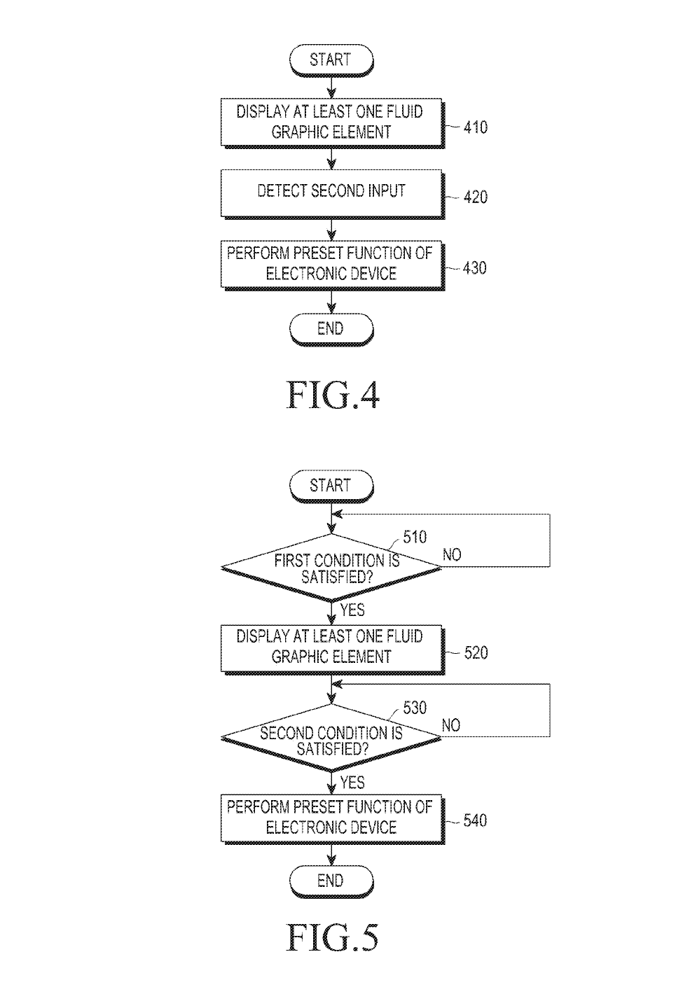

FIG. 4 is a flowchart illustrating a method for operating an electronic device according to various embodiments of the present disclosure. Referring to FIG. 4, the method for operating the electronic device includes steps 410 through 430. The method may be performed by an electronic device 101 or 201 or a processor 120 or 210 of the electronic device.

In step 410, the electronic device displays at least one fluid graphic element on a display 160 or 260. The electronic device may transparently (or opaquely) display at least one fluid graphic element on a background image, a home screen or an application screen on the display.

According to an embodiment of the present disclosure, the electronic device may transparently (or opaquely) display at least one fluid graphic element on a lock screen on the display. For example, the electronic device may operate in a lock mode in which at least some functions of the electronic device are limited, and in the lock mode, the electronic device may display a preset screen (that is, a lock screen) on the display. For example, the lock screen may include a preset background image. The lock screen may include the background image and an input means (e.g., a password input means, a pattern input means, and/or the like) displayed on the background image to unlock the lock screen or lock mode of the electronic device. The lock screen may include the background image and at least one preset item (e.g., buttons, icons, menus, menu items, and/or the like) displayed on the background image. For example, a preset item may include an item for an emergency call/message, an item for photographing, and so forth.

The fluid graphic element may have the form of a drop (e.g., a drop of water, a drop of oil, and/or the like). In an embodiment of the present disclosure, the electronic device automatically (or periodically) generates at least one fluid graphic element.

The electronic device automatically generates a fluid graphic element if a preset first condition is satisfied (or an event occurs). For example, the preset first condition may include when a context associated with the electronic device, which coincides with a preset context, is detected, when an event (e.g., reception of a message, generation of an alert message, and/or the like) requiring notification to a user occurs, when the electronic device is positioned at or arrives in a preset area/place, when the electronic device enters the lock mode, when a preset time (e.g., an alarm time, a preset schedule item, and/or the like) elapses, when the electronic device operates according to a preset operation pattern (e.g., execution of application(s), and/or the like), when a user's biometric information matches a preset state (e.g., the biometric information falls within a threshold range or is greater than, less than, or equal to a threshold value), when an attribute value (e.g., the remaining memory level, a signal reception strength, and/or the like) indicating a current state of the electronic device falls within a preset threshold range or is greater than, less than, or equal to a preset threshold value, and/or when the current state (e.g., a battery state, a wireless signal reception state, a memory state, and/or the like) of the electronic device matches a preset state (e.g., the current state falls within a threshold range or is greater than, less than, or equal to a threshold value).

According to an embodiment of the present disclosure, the electronic device receives a message (e.g., a text message) from an external device through a communication interface (e.g., the communication interface 170 or the communication module 220). Upon receipt of the message, the electronic device automatically generates at least one fluid graphic element.

The electronic device detects a context associated with the electronic device. The electronic device searches for information associated with the context in a database stored in a memory (e.g., the memory 130 or 230) of the electronic device. Once the information associated with the context is searched for in the database, the electronic device automatically generates at least one fluid graphic element.

According to an embodiment of the present disclosure, the electronic device detects a user's biometric information (e.g., a heart rate, a blood pressure, a temperature, and/or the like) using a biometric sensor (e.g., the biometric sensor 240I). If the detected biometric information falls within a preset threshold range or is greater than, less than, or equal to a preset threshold value, the electronic device automatically generates at leak one fluid graphic element.

According to an embodiment of the present disclosure, the electronic device generates at least one fluid graphic element in response to a first input. The first input may include a touch input or a hovering input on the display. The first input may also include a voice input or a gesture input. For example, the electronic device may receive a user's voice (e.g., a voice input through a microphone) through an I/O interface (e.g., the I/O interface 150 or the microphone 288). If a word matching at least one preset word is detected from the voice, the electronic device may generate at least one fluid graphic element.

In response to the first input, the electronic device generates at least one fluid graphic element and gradually increases a size of the generated fluid graphic element and moves the generated fluid graphic element along a trajectory of the first input. In response to the first input, the electronic device generates the fluid graphic element that gradually protrudes from a display region boundary of the display and moves the generated fluid graphic element toward a central portion of the display.

According to an embodiment of the present disclosure, in response to the first input, the electronic device generates a plurality of fluid graphic elements. At step 420, the electronic device detects a second input associated with the fluid graphic element. The second input may include a touch input or a hovering input, a touch input or a hovering input lasting a preset time, a swipe input or a drag input, a swipe input or a drag input in a preset direction, or a swipe input or a drag input to a predetermined position with respect to the fluid graphic element.

According to an embodiment of the present disclosure, the electronic device generates the fluid graphic element in response to the first input (e.g., a touch input or a hovering input on the display), and the second input includes a swipe input or a drag input continuing from the first input or the second input includes a swipe input or a drag input that lasts a preset time continuously from the first input.

In step 430, in response to the second input, the electronic device performs a preset function of the electronic device. In response to the second input, the electronic device transforms the fluid graphic element. If an attribute of the transformed fluid graphic element satisfies a preset condition, the electronic device may perform a preset function.

In response to the second input, the electronic device moves the fluid graphic element. If at least one attribute of the moved fluid graphic element satisfy a preset condition, the electronic device may perform a preset function.

In response to the second input, the electronic device transforms and/or moves the fluid graphic element. If at least one attribute of the transformed and/or moved fluid graphic element satisfies a preset condition, the electronic device may perform a preset function. The attributes may include information associated with a size, an area, a number, an arrangement, or a position of the transformed and/or moved fluid graphic element.

According to an embodiment of the present disclosure, in response to the second input, the electronic device unlocks the electronic device or releases restriction of use of at least one function of the electronic device.

In response to the second input, the electronic device removes a visual effect applied to at least a portion of a screen of the display. For example, the visual effect may include a blur effect for blurring at least a portion of the screen of the display, a dim effect for dimming at least a portion of the screen of the display, a masking effect for displaying a preset image on at least a portion of the screen of the display, and a transparent effect for transparently displaying at least a portion of the screen of the display. In response to the second input, the electronic device executes or displays a preset application.

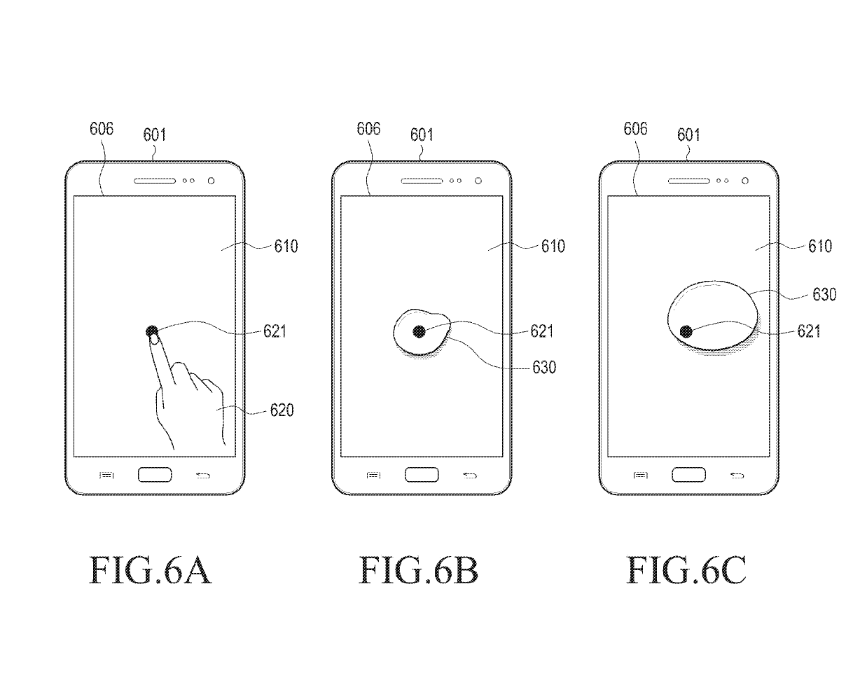

FIG. 5 is a flowchart illustrating a method for operating an electronic device according to various embodiments of the present disclosure. Referring to FIG. 5, the method for operating the electronic device includes steps 510 through 540. The method may be performed by an electronic device or a processor of the electronic device.

In step 510, the electronic device determines whether a preset first condition is satisfied. The electronic device performs step 520 if the preset first condition is satisfied, and periodically repeats step 510 unless the preset first condition is satisfied.

According to an embodiment of the present disclosure, the preset first condition may include when the first input is detected, when a context associated with the electronic device which coincides with a preset context is detected, when an event (e.g., reception of a message, generation of an alert message, or the like) requiring notification to a user occurs, when the electronic device is positioned or arrives at a preset area/place, when the electronic device enters the lock mode; when a preset time (e.g., an alarm time, a preset schedule item, and/or the like) elapses, when the electronic device operates according to a preset operation pattern (e.g., execution of application(s), and/or the like), when user's biometric information matches a preset state (e.g., the biometric information falls within a threshold range or is greater than, less than, or equal to a threshold value), when an attribute value (e.g., the remaining memory level, a signal reception strength, and/or the like) indicating a current state of the electronic device falls within a preset threshold range or is greater than, less than, or equal to a preset threshold value, and/or when the current state (e.g., a battery state, a wireless signal reception state, a memory state, and/or the like) of the electronic device matches a preset state (e.g., the current state falls within a threshold range or is greater than, less than, or equal to a threshold value).

According to an embodiment of the present disclosure, the first input includes a touch input and a hovering input on the display, a voice input, and/or a gesture input.

In step 520, if the preset first condition is satisfied, the electronic device displays at least one fluid graphic element on the display.

In step 530, the electronic device determines whether a preset second condition associated with the fluid graphic element is satisfied. The electronic device performs step 540 if the preset second condition is satisfied, and periodically repeats step 530 until the preset second condition is satisfied.

According to an embodiment of the present disclosure, the preset second condition may include when the second input is detected, when a context associated with the electronic device which coincides with a preset context is detected, when at least one fluid graphic element is positioned or arrives at a preset screen region on the display, when a preset time elapses from a point in time when the fluid graphic element is generated (or after that point in time), when the fluid graphic element is moved according to a preset moving pattern, when a current attribute value (e.g., a size, an area, a number, an arrangement, or position) of the fluid graphic element satisfies a preset condition, or falls within a preset threshold range, or is greater than, less than, or equal to a preset threshold value, and/or when a current shape/state/position (e.g., a size, an area, a number, an arrangement, or a position) of the fluid graphic element matches a preset shape/state/position.

According to an embodiment of the present disclosure, the second input may include a touch input or a hovering input with respect to the fluid graphic element, a touch input or a hovering input lasting a preset time with respect to the fluid graphic element, a swipe input or a drag input with respect to the fluid graphic element, a swipe input or a drag input in a preset direction with respect to the fluid graphic element and/or a swipe input or a drag input to a predetermined position with respect to the fluid graphic element.

In step 540, if the preset second condition is satisfied, the electronic device performs a preset function.

According to an embodiment of the present disclosure, in response to the second input, the electronic device transforms or moves the fluid graphic element. If at least one attribute of the transformed or moved fluid graphic element satisfies a preset condition, the electronic device may perform a preset function. The attributes may include information associated with a size, an area, a number, an arrangement, or a position of the transformed or moved fluid graphic element.

According to an embodiment of the present disclosure, the preset function of the electronic device may include unlocking of the electronic device, releasing restriction of use of at least one function of the electronic device, removing a visual effect applied to at least a portion of a screen of the display, executing or displaying a preset application and/or displaying preset information.

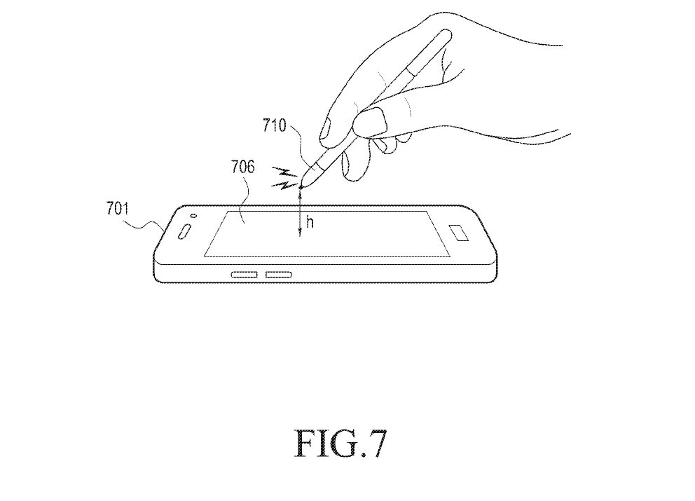

FIGS. 6A to 6C illustrate views for describing a method for operating an electronic device according to various embodiments of the present disclosure. The method for operating the electronic device may be performed by an electronic device 601 or a processor of the electronic device 601.

Referring to FIG. 6A, the electronic device 601 detects a first input 621 with respect to a screen 610 (e.g., a background image, an application screen, a home screen, a lock screen, and/or the like) displayed on a display 606. For example, a user 620 may generate a touch input or a hovering input in a predetermined position on the screen 610 by using a finger or a pen.

Referring to FIG. 6B, in response to the first input 621, the electronic device 601 transparently (or opaquely) generates and displays a fluid graphic element 630 on the screen 610 displayed on the display 606. For example, the electronic device 601 may generate and display the fluid graphic element 630 in a position of the first input 621. The fluid graphic element may have the form of a drop (e.g., a drop of water, a drop of oil, and/or the like).

Referring to FIG. 6C, the electronic device 601 gradually increases a size of the generated fluid graphic element 630. For example, the electronic device 601 may generate the fluid graphic element 630 that gradually increases in size at the position of the first input 621.

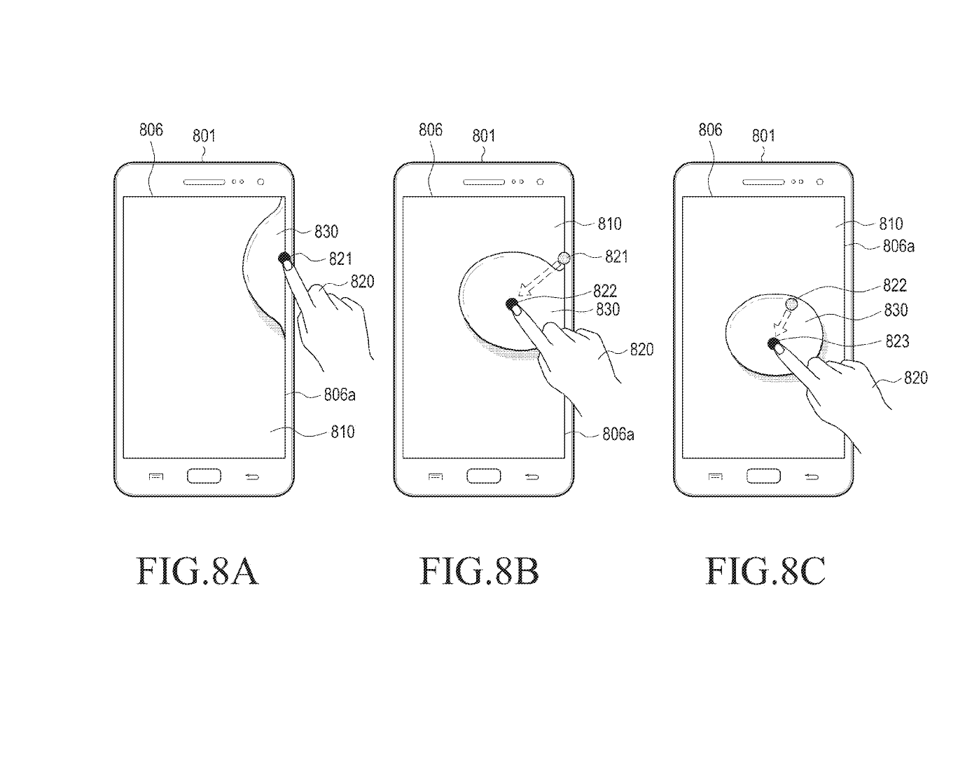

FIG. 7 is a view for describing a hovering input. Referring to FIG. 7, when a user situates an input unit 710 (e.g., a pen or a body part such as a finger) within a threshold distance h above the surface of a display 706 of an electronic device 701, the display 706 detects a hovering input of the input unit 710. The display 706 outputs information about the hovering input (e.g., a position, a strength, a distance, and/or the like of the hovering input) to a processor of the electronic device.

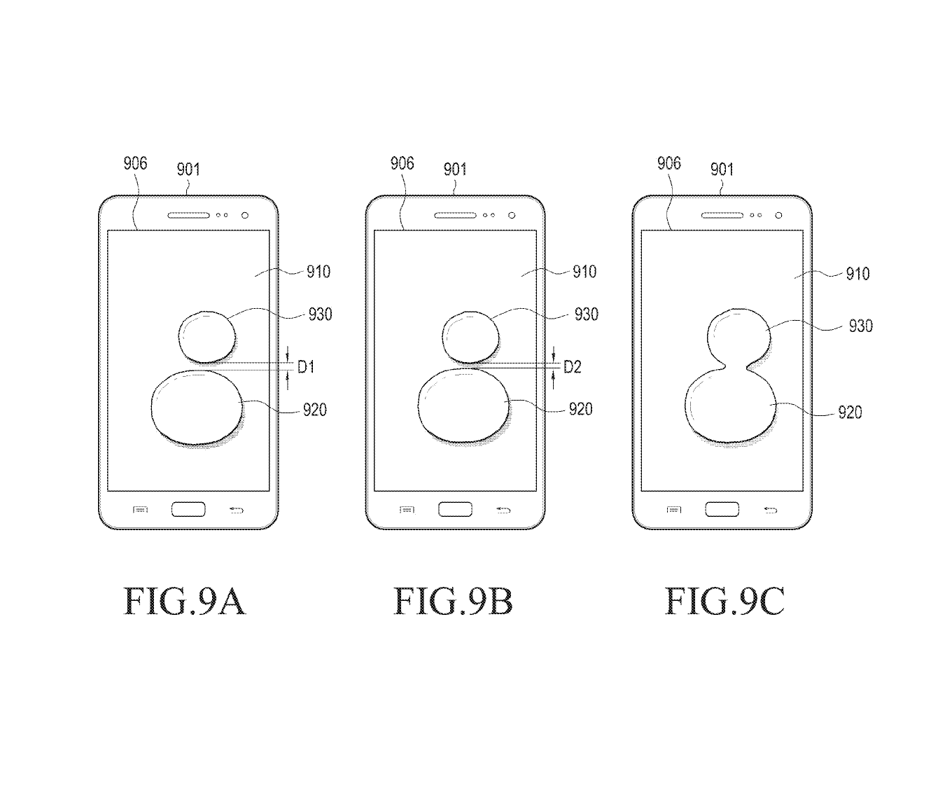

FIGS. 8A to 8C illustrate views for describing a method for operating an electronic device according to various embodiments of the present disclosure. The method for operating the electronic device may be performed by an electronic device 801 or a processor of the electronic device 801.

Referring to FIG. 8A, the electronic device 801 detects a first input 821 with respect to a screen 810 (e.g., a background image, an application screen, a home screen, a lock screen, and/or the like) displayed on a display 806. For example, a user 820 may perform a touch input or a hovering input in a right side display region boundary 806a of the display 806 by using a finger or a pen.

In response to the first input 821, the electronic device 801 generates a fluid graphic element 830 that gradually protrudes from the display region boundary 806a of the display 806 toward a central portion of the display 806. For example, the electronic device 801 may generate and display the fluid graphic element 830 that gradually protrudes from a position of the first input 821.

Referring to FIGS. 8B and 8C, according to position movement of the first inputs 821, 822, and 823 (that is, a swipe input or a drag input), the electronic device 801 moves the fluid graphic element 830. For example, the electronic device 801 may move the fluid graphic element 830 on a real time basis along trajectories of the first inputs 821, 822, and 823.

According to an embodiment of the present disclosure, if the user 820 generates a first input (e.g., a touch input, a hovering input, and/or the like) in which there is no position movement on the display 806 (e.g., the display region boundary 806a of the display 806 or the central portion of the display 806), the electronic device 801 generates the fluid graphic element that gradually protrudes from the display region boundary 806a of the display 806 toward the central portion of the display 806, and moves the generated fluid graphic element to the central portion of the display 806.

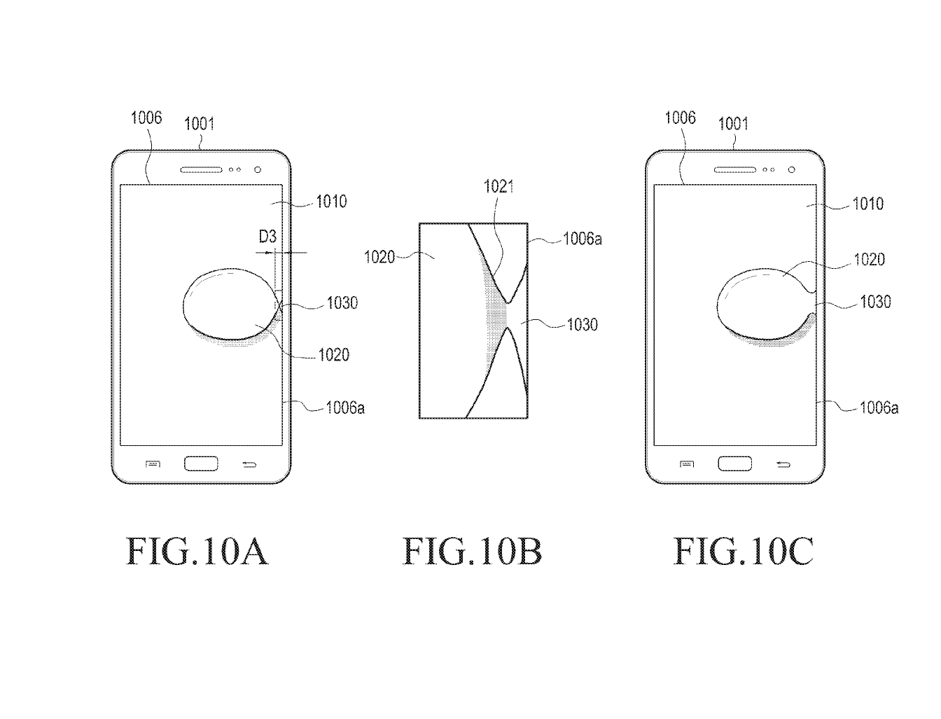

FIGS. 9A to 9C illustrate views for describing a method for operating an electronic device according to various embodiments of the present disclosure. The method for operating the electronic device may be performed by an electronic device 901 or a processor of the electronic device 901.

Referring to FIG. 9A, the electronic device 901 transparently (or opaquely) generates and displays a first fluid graphic element 920 and a second fluid graphic element 930 on a screen 910 of a display 906. For example, the electronic device 901 may detect a single input or a plurality of inputs of a user with respect to the screen 910 displayed on the display 906, and may display the plurality of fluid graphic elements 920 and 930 in response to the single input or the plurality of inputs.

The electronic device 901 detects a distance D1 between the first fluid graphic element 920 and the second fluid graphic element 930 (e.g., a distance between an edge (or an end) of the first fluid graphic element 920 and an edge (or an end) of the second fluid graphic element 930 or a distance between a center of the first fluid graphic element 920 and a center of the second fluid graphic element 930).

The electronic device 901 compares the distance D1 between the first fluid graphic element 920 and the second fluid graphic element 930 with a preset threshold distance. If the distance D1 between the first fluid graphic element 920 and the second fluid graphic element 930 is greater than the threshold distance, the electronic device 901 may not connect the first fluid graphic element 920 with the second fluid graphic element 930.

Referring to FIG. 9B, according to size increase or position movement of the second fluid graphic element 930, the distance D1 between the first fluid graphic element 920 and the second fluid graphic element 930 may further decrease. The electronic device 901 compares a distance D2 between the first fluid graphic element 920 and the second fluid graphic element 930 with a preset threshold distance.

Referring to FIG. 9C, if the distance D2 between the first fluid graphic element 920 and the second fluid graphic element 930 is less than or equal to the threshold distance, the electronic device 901 connects the first fluid graphic element 920 with the second fluid graphic element 930. For example, an edge portion of the first fluid graphic element 920 may extend toward the second fluid graphic element 930, and an edge portion of the second fluid graphic element 930 may extend toward the first fluid graphic element 920.

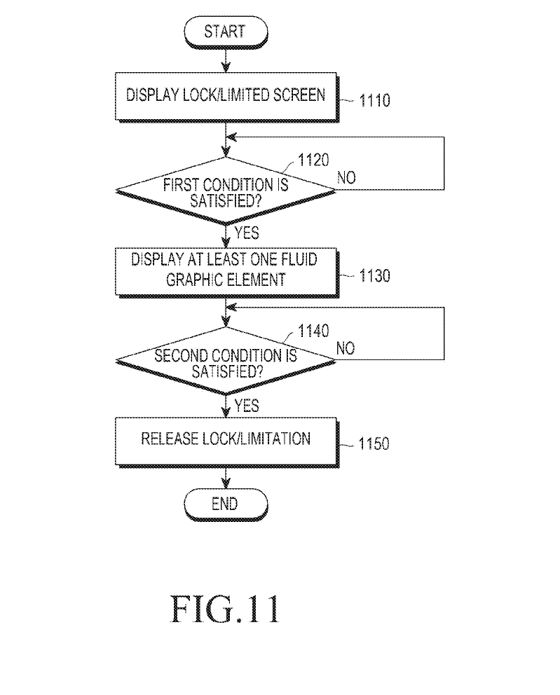

FIGS. 10A to 10C illustrate views for describing a method for operating an electronic device according to various embodiments of the present disclosure. The method for operating the electronic device may be performed by an electronic device 1001 or a processor of the electronic device 1001.

Referring to FIG. 10A, the electronic device 1001 transparently (or opaquely) generates and displays a fluid graphic element 1020 on a screen 1010 displayed on a display 1006.

The electronic device 1001 detects a distance D3 between the fluid graphic element 1020 and a right side display region boundary 1006a of the display 1006 (e.g., a distance between an edge (or an end) of the fluid graphic element 1020 and the display region boundary 1006a or a distance between a center of the fluid graphic element 1020 and the display region boundary 1006a). The electronic device 1001 compares the distance D3 between the fluid graphic element 1020 and the display region boundary 1006a with a preset threshold distance.

Referring to FIGS. 10B and 10C, if the distance D3 between the fluid graphic element 1020 and the display region boundary 1006a is less than or equal to the threshold distance, the electronic device 1001 connects the fluid graphic element 1020 with a boundary fluid graphic element. For example, the boundary fluid graphic element may be a virtual fluid graphic element that is positioned outside a display region of the display 1006 and is not displayed to the user, and an edge portion 1030 of the boundary fluid graphic element for connection with the fluid graphic element 1020 may be displayed to the user. An edge portion 1021 of the fluid graphic element 1020 may extend toward the display region boundary 1006a (or the boundary fluid graphic element), and the edge portion 1030 of the boundary fluid graphic element may extend toward the fluid graphic element 1020.

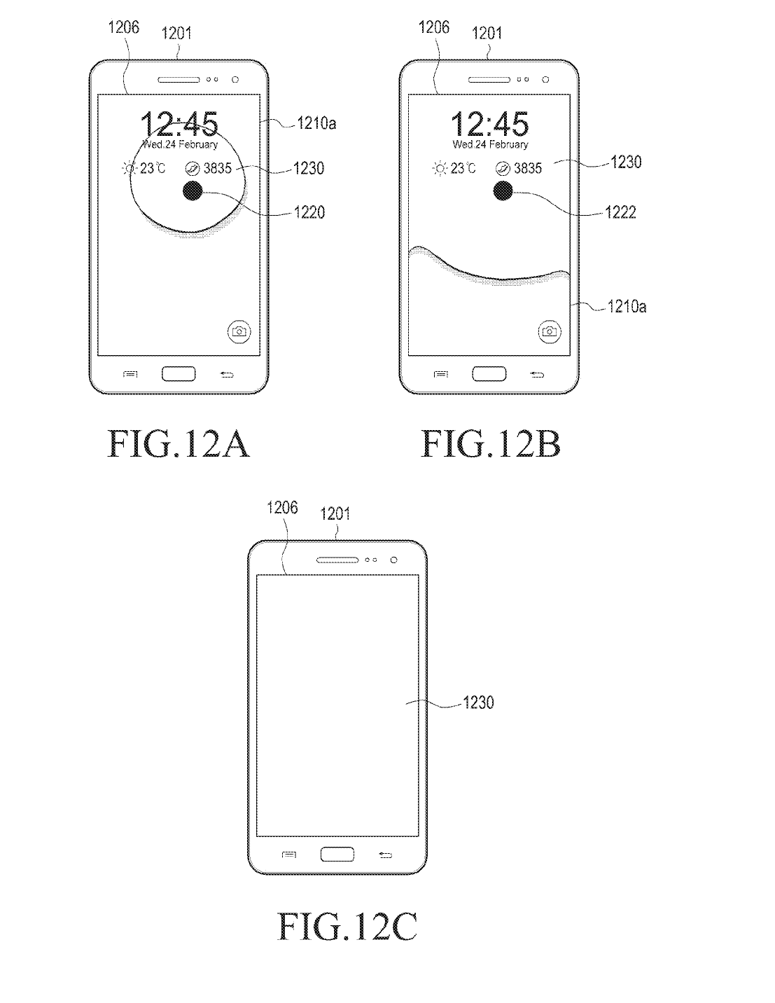

FIG. 11 is a flowchart for describing a method for operating an electronic device according to various embodiments of the present disclosure. The method for operating the electronic device includes steps 1110 through 1150. The method may be performed by an electronic device or a processor of the electronic device.

In step 1110, the electronic device displays a lock screen or a limited screen on a display. According to an embodiment of the present disclosure, the electronic device operates in a lock mode in which at least some functions of the electronic device are limited, and in the lock mode, the electronic device displays a preset screen (that is, a lock screen) on the display. For example, the lock screen may include a preset background image. The lock screen may include the background image and an input means (e.g., a password input means, a pattern input means, and/or the like) displayed on the background image to unlock the screen or the mode of the electronic device. The lock screen may include the background image and at least one preset item (e.g., buttons, icons, menus, menu items, and/or the like) displayed on the background image. For example, the preset items may include an item for an emergency call/message, an item for photographing, and/or the like.

According to an embodiment of the present disclosure, the electronic device operates in a limited mode in which displaying of information on the display is limited, and the electronic device applies a preset visual effect to at least a portion of the screen in the limited mode. For example, the visual effect may include a blur effect for blurring at least a portion of the screen of the display, a dim effect for dimming at least a portion of the screen of the display, a masking effect for displaying a preset image on at least a portion of the screen of the display, and/or a transparent effect for transparently displaying at least a portion of the screen of the display.

In step 1120, the electronic device determines whether a preset first condition is satisfied. The electronic device performs step 1130 if the preset first condition is satisfied, and periodically repeats step 1120 unless the preset first condition is satisfied.

According to an embodiment of the present disclosure, the preset first condition may include when the first input is detected, when a context associated with the electronic device, which coincides with a preset context, is detected, when an event (e.g., reception of a message, generation of an alert message, and/or the like) requiring notification to a user occurs, when the electronic device is positioned or arrives at a preset area/place, when the electronic device enters the lock mode, when a preset time (e.g., an alarm time, a preset schedule item, and/or the like) elapses, when the electronic device operates according to a preset operation pattern (e.g., execution of application(s), and/or the like), when a user's biometric information matches a preset state (e.g., the biometric information falls within a threshold range or is greater than, less than, or equal to a threshold value), when an attribute value (e.g., the remaining memory level, a signal reception strength, and/or the like) indicating a current state of the electronic device falls within a preset threshold range or is greater than, less than, or equal to a preset threshold value, and/or when the current state (e.g., a battery state, a wireless signal reception state, a memory state, and/or the like) of the electronic device matches a preset state (e.g., the current state falls within a threshold range or is greater than, less than, or equal to a threshold value).

According to an embodiment of the present disclosure, the first input includes a touch input and a hovering input on the display, a voice input, and/or a gesture input.

In step 1130, if the preset first condition is satisfied, the electronic device displays at least one fluid graphic element on a display (e.g., the display 160 or 260).

In step 1140, the electronic device determines whether a preset second condition associated with the fluid graphic element is satisfied. The electronic device performs step 1150 if the preset second condition is satisfied, and periodically repeats step 1140 unless the preset second condition is satisfied.

According to an embodiment of the present disclosure, the preset second condition may include when the second input is detected, when a context associated with the electronic device, which coincides with a preset context, is detected, when the fluid graphic element is positioned or arrives at a preset screen region on the display, when a preset time elapses from a point in time when the fluid graphic element is generated (or after that point in time), when the fluid graphic element is moved according to a preset moving pattern, when a current attribute value (e.g., a size, an area, a number, an arrangement, or position) of the fluid graphic element satisfies a preset condition or falls within a preset threshold range or is greater than, less than, or equal to a preset threshold value, and/or when a current shape/state/position (e.g., a size, an area, a number, an arrangement, or a position) of the at least one fluid graphic element matches a preset shape/state/position.

According to an embodiment of the present disclosure, the second input may include a touch input or a hovering input with respect to the fluid graphic element, a touch input or a hovering input lasting a preset time with respect to the fluid graphic element, a swipe input or a drag input with respect to the fluid graphic element, a swipe input or a drag input in a preset direction with respect to the fluid graphic element and/or a swipe input or a drag input to a predetermined position with respect to the fluid graphic element.

In step 1150, when the preset second condition is satisfied, the electronic device performs a preset function.

According to an embodiment of the present disclosure, in response to the second input, the electronic device transforms or moves the fluid graphic element. If at least one attribute of the transformed or moved fluid graphic element satisfies a preset condition, the electronic device may perform a preset function. The attribute may include information associated with a size, an area, a number, an arrangement, or a position of the transformed or moved fluid graphic element.

According to an embodiment of the present disclosure, the preset function of the electronic device may include an unlocking of the electronic device, releasing restriction of use of at least one function of the electronic device, removing a visual effect applied to at least a portion of a screen of the display, executing or displaying a preset application and/or displaying preset information.

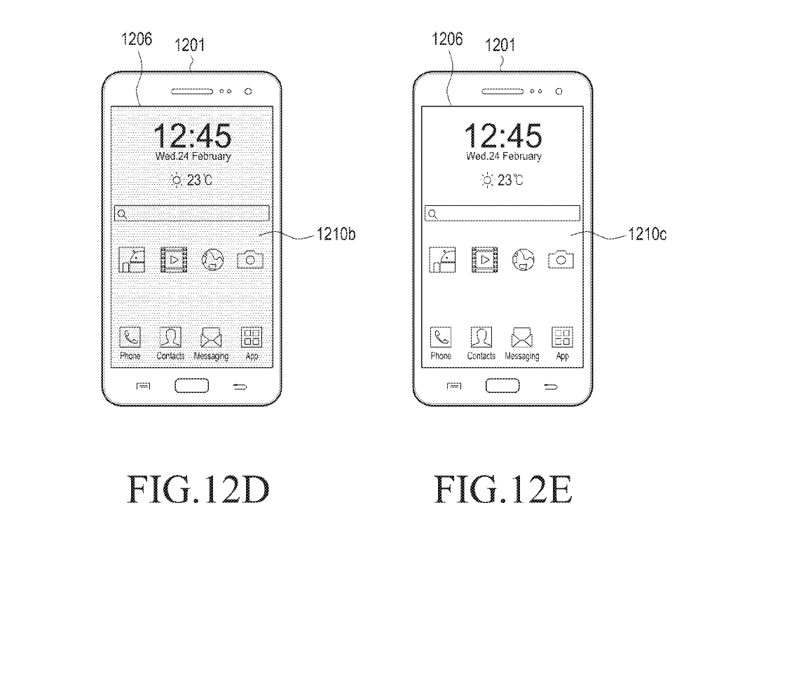

FIGS. 12A to 12E are views for describing a method for operating an electronic device according to various embodiments of the present disclosure. The method may be performed by an electronic device 1201 or a processor of the electronic device 1201.

Referring to FIG. 12A, the electronic device 1201 displays a lock/limited screen 1210a on a display 1206. The lock/limited screen 1210a may be a screen generated by applying a blur effect to an original screen 1210c as shown in FIG. 12E. The lock/limited screen 1210a may include at least one preset item (e.g., buttons, icons, menus, and menu items). For example, the preset items may include current time, weather, temperature, biometric information (e.g., the number of steps taken, a pulse rate, and/or the like), brief information of a social network service (SNS), an item for an emergency call/message, and/or an item for photographing.

The electronic device 1201 detects a first input 1220 with respect to the lock/limited screen 1210a displayed on the display 1206. For example, the user may generate the first input 1220 (e.g., a touch input or a hovering input) at a predetermined position on the lock/limited screen 1210a by using a finger or a pen.

In response to the first input 1220, the electronic device 1201 transparently (or opaquely) generates and displays a fluid graphic element 1230 on the lock/limited screen 1210a displayed on the display 1206. For example, the electronic device 1201 may generate and display the fluid graphic element 1230 at a position of the first input 1220.

Referring to FIG. 12B, the electronic device 1201 detects a second input 1222 with respect to the fluid graphic element 1230. For example, the second input 1222 may be an input that lasts a preset time continuously from the first input 1220.

In response to the first input 1220 or the second input 1222, the electronic device 1201 gradually (or continuously) increases a size or an area of the fluid graphic element 1230 for a duration of the first input 1220 or the second input 1222.

Referring to FIG. 12C, in response to the first input 1220 or the second input 1222 or if a current attribute value (e.g., a size, an area, a number, an arrangement, or a position) of the fluid graphic element 1230 satisfies a preset condition or falls within a preset threshold range or is greater than, less than, or equal to a preset threshold value, the electronic device 1201 enlarges and displays the fluid graphic element 1230 in the entire display region of the display 1206 (or the remaining region of the entire display region except for a status bar indicating a remaining battery level, a signal reception strength, a current time, and/or the like).

Referring to FIG. 12E, in response to the first input 1220 or the second input 1222, or if the current attribute value (e.g., a size, an area, a number, arrangement, or a position) of the fluid graphic element 1230 satisfies the preset condition or falls within the preset threshold range or is greater than, less than, or equal to the preset threshold value, the electronic device 1201 displays the original screen 1210c in which lock/limitation is released.

According to an embodiment of the present disclosure, the original screen 1210c may be a home screen or an application screen. The home screen may include a status bar for indicating application updates, a state of a short-range communication module, a received signal strength, a time, an icon for displaying a list of all applications, an icon for displaying a list of recently used applications, a background screen for displaying icons of separate applications, and/or a menu including a search icon or a home icon.

Referring to FIG. 12D, the electronic device 1201 gradually removes the limitation (e.g., the blur effect) and gradually or continuously displays an intermediate screen 1210b in which the limitation is gradually removed.

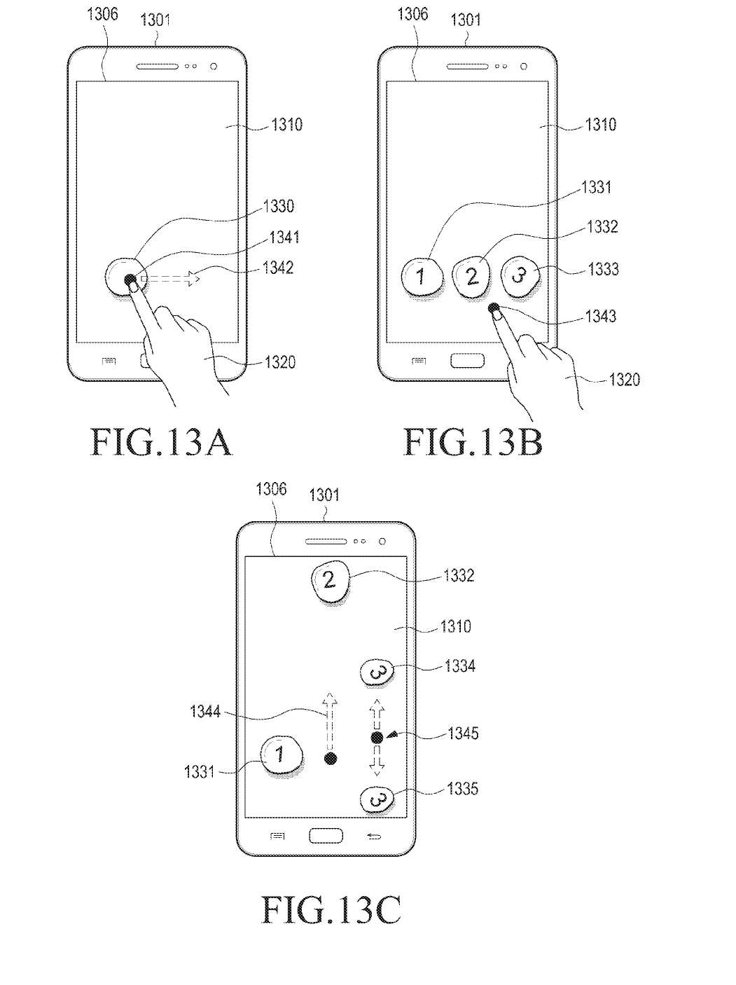

FIGS. 13A to 13C are views for describing a method for operating an electronic device according to various embodiments of the present disclosure. The method for operating the electronic device may be performed by an electronic device 1301 or a processor of the electronic device 1301.

The electronic device 1301 displays a lock/limited screen 1310 on a display 1306. The lock/limited screen 1310 may be a screen generated by applying the blur effect to the original screen. The lock/limited screen 1310 may include at least one preset item (e.g., buttons, icons, menus, and menu items). For example, the preset items may include at least one of current time, weather, temperature, biometric information (e.g., the number of steps taken, a pulse rate, and/or the like), brief information of an SNS, an item for an emergency call/message, and/or an item for photographing.

Referring to FIG. 13A, in response to a first input 1341 of a user 1320, the electronic device 1301 transparently (or opaquely) generates and displays a fluid graphic element 1330 on a lock/limited screen 1310 displayed on the display 1306. For example, the electronic device 1301 may generate and display the fluid graphic element 1330 at a position of the first input 1341.

In response to a second input 1342 of the user 1320, the electronic device 1301 releases the lock/limitation. For example, the second input 1342 may be a swipe input or a drag input in a preset direction or to a preset position.

Referring to FIG. 13B, in response to a first input 1343 of the user 1320, the electronic device 1301 transparently (or opaquely) generates and displays a plurality of fluid graphic elements 1331, 1332, and 1333 on the lock/limited screen 1310 displayed on the display 1306. For example, the first input 1343 may be a hovering input.

According to an embodiment of the present disclosure, a preset item (e.g., a button, an icon, a menu, a menu item, a text, an image, and/or the like) may be displayed on a surface or inside of at least some of the plurality of fluid graphic elements 1331, 1332, and 1333.

In response to a second input of the user 1320, the electronic device 1301 may release the lock/limitation. For example, the second input may be an input for selecting at least one fluid graphic element 1331, 1332, or 1333, an input for moving or removing at least one fluid graphic element 1331, 1332, or 1333, an input for selecting at least some of the fluid graphic elements 1331, 1332, and 1333 according to a preset pattern, an input for connecting at least some of the fluid graphic elements 1331, 1332, and 1333 according to a preset pattern, an input for moving at least some of the fluid graphic elements 1331, 1332, and 1333 to combine them, or an input for dividing at least one fluid graphic element 1331, 1332, or 1333.

Referring to FIG. 13C, the electronic device 1301 detects a second input 1344 (e.g., a flick input/gesture of rapidly moving an input unit on the display 1306 and then removing the input unit) with respect to the second fluid graphic element 1332. In response to the second input 1344, the electronic device 1301 moves the second fluid graphic element 1332 to a display region boundary of the display 1306 to remove the second fluid graphic element 1332.

The electronic device 1301 detects a third input 1345 (e.g., a multi-swipe input/gesture of moving at least two input units (or fingers) a predetermined distance while keeping the at least two input units (or fingers) in contact with the display 1306) with respect to the third fluid graphic element 1333. In response to the third input 1345, the electronic device 1301 divides the third fluid graphic element 1332 into two fluid graphic elements 1334 and 1335.

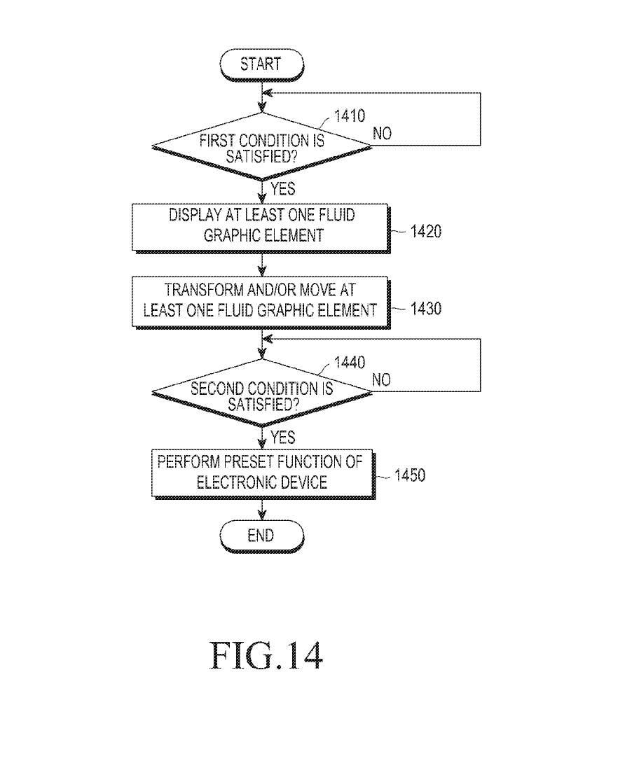

FIG. 14 is a flowchart illustrating a method for operating an electronic device according to various embodiments of the present disclosure. The method for operating the electronic device includes steps 1410 through 1450. The method may be performed by an electronic device or a processor of the electronic device.

In step 1410, the electronic device determines whether a preset first condition is satisfied. The electronic device performs step 1420 if the preset first condition is satisfied, and periodically repeats step 1410 unless the preset first condition is satisfied.

According to an embodiment of the present disclosure, the preset first condition may include when the first input is detected, when a context associated with the electronic device, which coincides with a preset context, is detected, when an event (e.g., reception of a message, generation of an alert message, and/or the like) requiring notification to a user occurs, when the electronic device is positioned or arrives at a preset area/place, when the electronic device enters the lock mode, when a preset time (e.g., an alarm time, a preset schedule item, and/or the like) elapses, when the electronic device operates according to a preset operation pattern (e.g., execution of application(s), and/or the like), when a user's biometric information matches a preset state (e.g., the biometric information falls within a threshold range or is greater than, less than, or equal to a threshold value), when an attribute value (e.g., the remaining memory level, a signal reception strength, and/or the like) indicating a current state of the electronic device falls within a preset threshold range or is greater than, less than, or equal to a preset threshold value, and/or when the current state (e.g., a battery state, a wireless signal reception state, a memory state, and/or the like) of the electronic device matches a preset state (e.g., the current state falls within a threshold range or is greater than, less than, or equal to a threshold value).

According to an embodiment of the present disclosure, the first input includes a touch input and a hovering input on the display, a voice input, and/or a gesture input.

In step 1420, when the preset first condition is satisfied, the electronic device displays at least one fluid graphic element on a display.

In step 1430, the electronic device automatically transforms and/or moves the at least one fluid graphic element.

According to an embodiment of the present disclosure, the electronic device transforms and/or moves the fluid graphic element based on information (e.g., position/orientation/direction/inclination/motion information, biometric information, and/or signal reception/strength information) detected by a sensor module (e.g., the sensor module 240) or a communication interface (e.g., the communication interface 170 or the communication module 220).

In step 1440, the electronic device determines whether a preset second condition associated with the fluid graphic element is satisfied. The electronic device performs step 1450 if the preset second condition is satisfied, and periodically repeats step 1440 unless the preset second condition is satisfied.

According to an embodiment of the present disclosure, the preset second condition may include when the second input is detected, when a context associated with the electronic device, which coincides with a preset context, is detected, when the fluid graphic element is positioned or arrives at a preset screen region on the display, when a preset time elapses from a point in time when the fluid graphic element is generated (or after that point in time), when the fluid graphic element is moved according to a preset moving pattern, when a current attribute value (e.g., a size, an area, a number, an arrangement, or position) of the fluid graphic element satisfies a preset condition or falls within a preset threshold range or is greater than, less than, or equal to a preset threshold value, and/or when a current shape/state/position (e.g., a size, an area, a number, an arrangement, or a position) of the fluid graphic element matches a preset shape/state/position.

In step 1450, when the preset second condition is satisfied, the electronic device performs a preset function.

According to an embodiment of the present disclosure, if a current attribute value (e.g., a size, an area, a number, an arrangement or a position) of the transformed and/or moved fluid graphic element satisfies a preset condition or falls within a preset threshold range or is greater than, less than, or equal to a preset threshold value, or if a current shape/state/position (e.g., a size, an area, a number, an arrangement or a position) of the transformed and/or moved fluid graphic element matches a preset shape/state/position, the electronic device may perform a preset function.

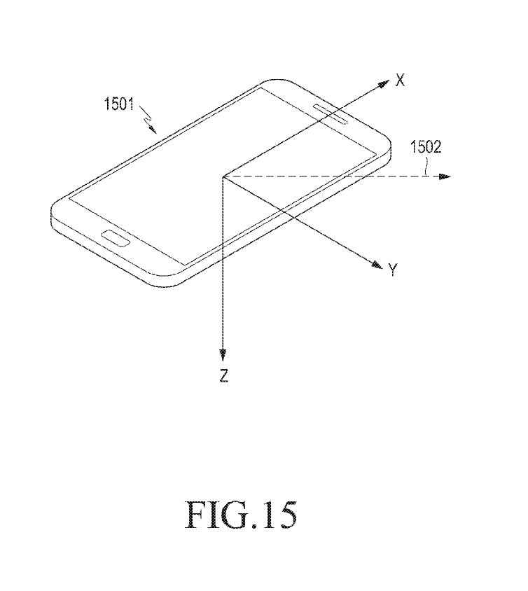

FIG. 15 is a view for describing a method for determining a position of an electronic device according to various embodiments of the present disclosure.

Referring to FIG. 15, assuming that an electronic device 1501 has a shape of a rectangular bar, an X axis corresponding to a vertical direction (or a lengthwise direction) of the electronic device 1501 is set, a Y axis corresponding to a horizontal direction (or a widthwise direction) of the electronic device 1501 is set, and a Z axis perpendicular to the X axis and the Y axis (a direction perpendicular to the surface of a display) is set.

The electronic device 1501 determines position/orientation/direction/inclination of the electronic device 1501 based on information of the electronic device 1501 detected by a sensor module (e.g., the sensor module 240). For example, the electronic device 1501 may determine position/orientation/direction/inclination of the electronic device 1501 with respect to a gravitational direction 1502 (e.g., an angle formed between the X axis, the Y axis and/or the Z axis and the gravitational direction 1502).

According to an embodiment of the present disclosure, the electronic device 1501 automatically transforms and/or moves at least one fluid graphic element based on the determined position/orientation/direction/inclination.

The electronic device 1501 determines transformation/movement speed of the fluid graphic element based on the determined position/orientation/direction/inclination. The electronic device 1501 may set the transformation/movement speed of the fluid graphic element to a maximum value if the determined position/orientation/direction/inclination coincides with (or is parallel to) the gravitational direction 1502. The electronic device 1501 may set the transformation/movement speed of the at least one fluid graphic element to 0, if the determined position/orientation/direction/inclination is perpendicular to the gravitational direction 1502. The electronic device 1501 may increase or decrease the transformation/movement speed of the fluid graphic element according to a degree to which the determined position/orientation/direction/inclination coincides with (or is parallel to) the gravitational direction 1502.

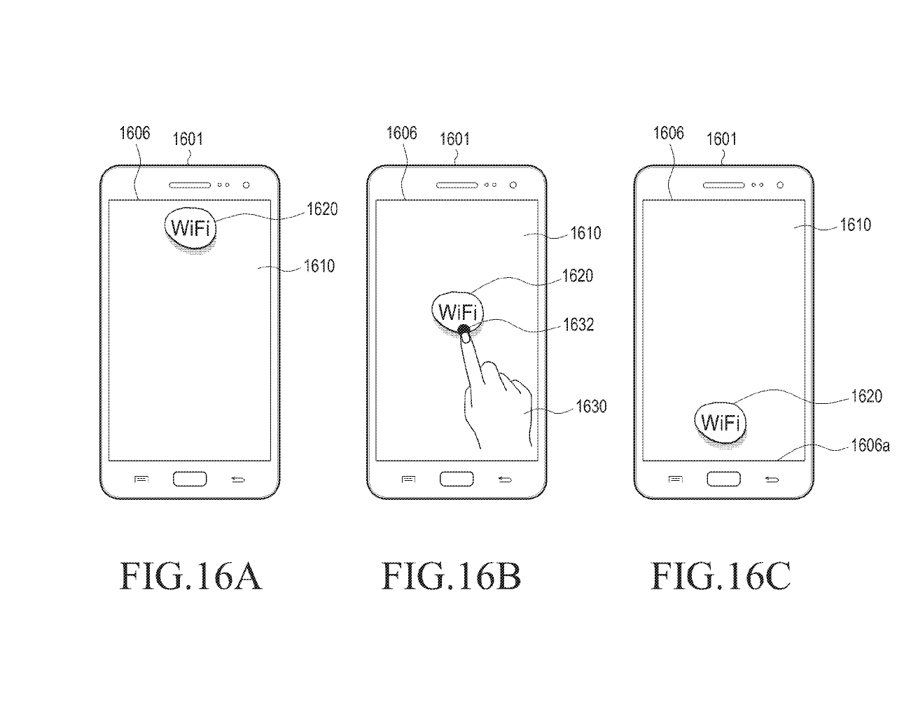

FIGS. 16A to 16C illustrate views for describing a method for operating an electronic device according to various embodiments of the present disclosure. The method may be performed by an electronic device 1601 or a processor of the electronic device 1601.

Referring to FIG. 16A, if discovering an external device (e.g., the first external electronic device 102, the second external electronic device 104, or the server 106), receiving a connection request from an external device, receiving a response request from an external device, or connecting to an external device, the electronic device 1601 automatically displays a fluid graphic element 1620 (e.g., a fluid graphic element indicating connection with an access point (AP) supporting wireless fidelity (WiFi) on a display 1606)).

Referring to FIG. 16B, the electronic device 1601 automatically moves the fluid graphic element 1620 based on a gravitational direction and/or a position/orientation/direction/inclination of the electronic device 1601.

According to an embodiment of the present disclosure, the electronic device 1601 moves the fluid graphic element 1620 along a preset direction. The electronic device 1601 gradually increases or reduces a size of the fluid graphic element 1620 while fixing the fluid graphic element 1620.

During movement of the fluid graphic element 1620, the electronic device 1601 may detect a second input 1632 of a user 1630 with respect to the fluid graphic element 1620. In response to the second input 1632, the electronic device 1601 may not connect to the external device or may not respond to a request received from the external device (or may perform a reverse operation). For example, the electronic device 1601 may deactivate a communication module (e.g., the WiFi module 223) used for connection with the external device.

Referring to FIG. 16C, if the fluid graphic element 1620 arrives at a display region boundary 1606a of the display 1606 or disappears after the arrival, the electronic device 1601 may connect to the external device or respond to a request received from the external device (or may perform a reverse operation).

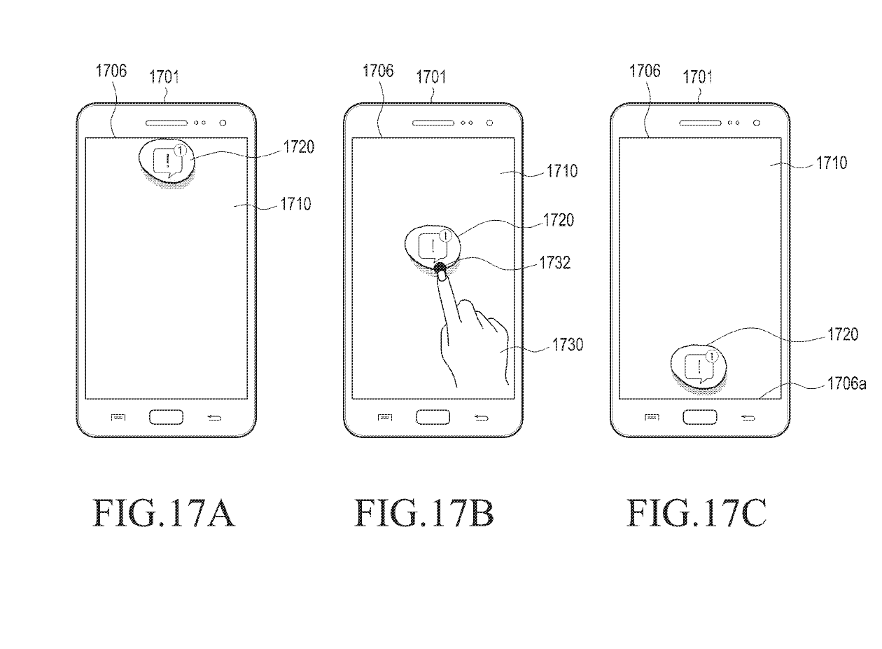

FIGS. 17A to 17C illustrate views for describing a method for operating an electronic device according to various embodiments of the present disclosure. The method may be performed by an electronic device 1701 or a processor of the electronic device 1701.

Referring to FIG. 17A, if receiving a message from an external device, the electronic device 1701 automatically generates a fluid graphic element 1720 (e.g., a fluid graphic element indicating reception of a message).

Referring to FIG. 17B, the electronic device 1701 automatically moves the fluid graphic element 1720 based on a gravitational direction and/or a position/orientation/direction/inclination of the electronic device 1701.

According to an embodiment of the present disclosure, the electronic device 1701 moves the fluid graphic element 1720 along a preset direction. The electronic device 1701 gradually increases or reduces a size of the fluid graphic element 1720 while fixing the fluid graphic element 1720.

During movement of the fluid graphic element 1720, the electronic device 1701 detects a second input 1732 of a user 1730 with respect to the fluid graphic element 1720. In response to the second input 1732, the electronic device 1701 displays details of a message, executes a message application, or displays a screen of a message application. Alternatively, the electronic device 1701 may wait until a next message display period, lengthen a message display period, or stop notifying of message reception.

Referring to FIG. 17C, if the fluid graphic element 1720 arrives at a display region boundary 1706a of a display 1706 or disappears after the arrival, the electronic device 1701 may wait until a next message display period, lengthen a message display period, or stop notifying message reception. In contrast, the electronic device 1701 may display details of a message, execute the message application, or display a screen of the message application.

According to an embodiment of the present disclosure, an electronic device may include a display configured to display a screen and a processor configured to display at least one fluid graphic element on the display, to determine whether a preset second condition associated with the fluid graphic element is satisfied, and to perform a preset function of the electronic device if the second condition is satisfied.

According to an embodiment of the present disclosure, the second condition may include when a second input associated with the fluid graphic element is detected, when a context associated with the fluid graphic element, which coincides with a preset context, is detected, when the fluid graphic element is positioned at or arrives at a preset screen region on the display, when a preset time elapses from generation of the fluid graphic element; when the fluid graphic element moves according to a preset moving pattern, when a current attribute value of the fluid graphic element falls within a preset threshold range or is greater than, less than, or equal to a preset threshold value, and/or when a current shape/state/position of the fluid graphic element coincides with a preset shape/state/position.

According to an embodiment of the present disclosure, the at least one fluid graphic element may be displayed on a background image on the display, transparently displayed on a background image displayed on the display, or displayed on a lock screen.

According to an embodiment of the present disclosure, the at least one fluid graphic element may have the form of a drop or the form of a drop of water.

According to an embodiment of the present disclosure, the processor may be configured to display the at least one fluid graphic element if the preset first condition is satisfied, the first condition may include when a context associated with the electronic device, which coincides with a preset context, is detected, when an event requiring notification to a user occurs, when the electronic device is positioned or arrives at a preset area/place, when the electronic device enters a lock mode, when a preset time elapses, when the electronic device operates according to a preset operation pattern, when a user's biometric information matches a preset state, when an attribute value indicating a current state of the electronic device falls within a preset threshold range or is greater than, less than, or equal to a preset threshold value, and/or when the current state of the electronic device matches a preset state.

According to an embodiment of the present disclosure, the processor may be configured to generate the fluid graphic element in response to the first input and the first input may include a touch input or a hovering input on the display, a voice input or a gesture input.

According to an embodiment of the present disclosure, the processor may be configured to generate the fluid graphic element in response to the first input and to gradually increase a size of the generated fluid graphic element or move the generated fluid graphic element along a trajectory of the first input.

According to an embodiment of the present disclosure, the processor may be configured to generate the at least one fluid graphic element that gradually protrudes from the display region boundary of the display toward the central portion of the display, and to move the generated at least one fluid graphic element to the central portion of the display, in response to the first input.

According to various embodiments of the present disclosure, the processor may be configured to display a boundary fluid graphic element that gradually protrudes from a display region boundary of the display toward a central portion of the display and automatically connect the fluid graphic element with the boundary fluid graphic element if a distance between an edge of the fluid graphic element and the display region boundary is less than or equal to a preset threshold value.

According to an embodiment of the present disclosure, the processor may be configured to automatically connect the fluid graphic element with another fluid graphic element displayed on the display if a distance between an edge of the at least one fluid graphic element and the another fluid graphic element is less than or equal to a preset threshold value.

According to an embodiment of the present disclosure, the processor may be configured to generate a plurality of fluid graphic elements in response to the first input and move the fluid graphic elements along a predetermined direction with respect to the electronic device.

According to an embodiment of the present disclosure, the processor may be configured to detect a gravitational direction and to move the fluid graphic element along the gravitational direction.

According to an embodiment of the present disclosure, the processor may be configured to detect position or inclination information of the electronic device and to move the fluid graphic element based on the position or inclination information.

According to an embodiment of the present disclosure, the processor may be configured to detect the position information of the electronic device and to move the fluid graphic element based on the position information, and a moving speed of the fluid graphic element may be determined based on the position information.

According to an embodiment of the present disclosure, the processor may be configured to generate the fluid graphic element in response to the first input, and the first input may include a touch input or a hovering input on the display, and the second condition may include when a second input associated with the fluid graphic element is detected, and the second input may include a swipe input or a drag input continuing from the first input.

According to an embodiment of the present disclosure, the processor may be configured to generate the fluid graphic element in response to the first input, and the first input may include a touch input or a hovering input on the display, and the second condition may include when a second input associated with the fluid graphic element is detected, and the second input may include a swipe input or a drag input lasting a preset time continuously from the first input.

According to an embodiment of the present disclosure, the second condition may include when the second input associated with the fluid graphic element is detected, and the second input may include a swipe input, a drag input, a touch input or a hovering input lasting a preset time, in a preset direction, or to a predetermined position with respect to the fluid graphic element.

According to an embodiment of the present disclosure, the processor may be configured to transform the at least one fluid graphic element, and to perform a preset function of the electronic device if at least one attributes of the transformed at least one fluid graphic element satisfy a preset condition.

According to an embodiment of the present disclosure, the processor may be configured to move the fluid graphic element, and to perform a preset function of the electronic device if at least one attribute of the moved fluid graphic element satisfy a preset condition.

According to an embodiment of the present disclosure, the processor may be configured to transform or move the fluid graphic element in response to the second input, and to perform the preset function of the electronic device if at least one attribute of the transformed or moved fluid graphic element satisfies a preset condition. The at least one attribute may include information associated with size, area, number, arrangement, or position of the transformed or moved fluid graphic element.

According to an embodiment of the present disclosure, the processor may be configured to unlock the electronic device, release use limitation of at least one function of the electronic device or remove a visual effect applied to a portion of the screen of the display

According to an embodiment of the present disclosure, the processor may be configured to remove the visual effect applied to a portion of the screen of the display, and the visual effect may include a blur effect for blurring a portion of the screen of the display, a dim effect for dimming the screen of the display, a masking effect for displaying a preset image on a portion of the screen of the display, and/or a transparent effect for transparently displaying a portion of the screen of the display.

According to an embodiment of the present disclosure, the processor may be configured to execute or display a preset application.

The term “module” as used herein may refer to, for example, a unit including one of, or a combination of, two or more of hardware, software, and firmware. The term “module” may be used interchangeably with the terms “unit”, “logic”, “logical block”, “component”, or “circuit”. The “module” may be a minimum unit or a portion of an integrated component. The “module” may be a minimum unit or a portion thereof performing one or more functions. The “module” may be implemented mechanically or electronically. For example, the “module” may include at least one of an application-specific integrated circuit (ASIC) chip, field-programmable gate arrays (FPGAs), and a programmable-logic device performing certain operations which is already known or to be developed.

At least a part of an electronic device (for example, modules or functions thereof) or a method (for example, operations) according to various embodiments of the present disclosure may be implemented with a command stored in a computer-readable storage medium in the form of a program module. When the command is executed by a processor (for example, the processor 120), the one or more processors may perform a function corresponding to the command. The computer-readable storage medium may be, for example, the memory 130.

The computer readable recording medium includes magnetic media such as a hard disk, floppy disk, magnetic tape, or optical media such as compact disc read only memory (CD-ROM) or digital versatile disc (DVD), magneto-optical media such as floptical disk, and a hardware device such as ROM, RAM, or flash memory for storing and executing program commands. Further, the program instructions include a machine language code created by a complier and a high-level language code executable by a computer using an interpreter. The foregoing hardware device may be configured to be operated as at least one software module to perform an operation of the present disclosure, or vice versa.

Modules or programming modules according to various embodiments of the present disclosure may include one or more of the foregoing elements, have some of the foregoing elements omitted, or further include additional other elements. Operations performed by the modules, the programming modules or other elements may be executed in a sequential, parallel, repetitive or heuristic manner. Also, some of the operations may be executed in a different order or omitted, or may have additional different operations.

According to an embodiment of the present disclosure, a storage medium is provided which has stored therein commands that are set, when executed by at least one processor, to cause the at least one processor to perform at least one operation including displaying at least one fluid graphic element on a display of the electronic device, determining whether a preset second condition associated with the at least one fluid graphic element is satisfied, and performing a preset function of the electronic device if determining that the second condition is satisfied.

The embodiments disclosed herein have been provided for description and understanding of disclosed technical matters, and do not limit the scope of the present disclosure. Therefore, it should be construed that the scope of the present disclosure includes any change or other various embodiments based on the technical spirit of the present disclosure.

As is apparent from the foregoing description, according to various embodiments of the present disclosure, by providing a UI using fluid graphic elements resembling a drop of water and/or the like, the user may be provided with an intuitive UI together with natural appearing graphic elements.

While the present disclosure has been particularly shown and described with reference to certain embodiments thereof, it will be understood by those of ordinary skill in the art that various changes in forms and details may be made therein without departing from the spirit and scope of the present disclosure and method as defined by the following claims and their equivalents.

What is claimed is:

1. A method for operating an electronic device, the method comprising:
displaying at least one fluid graphic element on a display of the electronic device;
determining whether a preset second condition associated with the at least one fluid graphic element is satisfied; and
performing a preset function of the electronic device if the second condition is satisfied.

2. The method of claim 1, wherein the second condition comprises at least one of when a second input is detected; when a context associated with the at least one fluid graphic element, which coincides with a preset context, is detected; when the at least one fluid graphic element is positioned at a preset screen region on the display; when a preset time elapses from generation of the at least one fluid graphic element; when the at least one fluid graphic element moves according to a preset moving pattern; when a current attribute value of the at least one fluid graphic element falls within a preset threshold range; and when a current position of the at least one fluid graphic element coincides with a preset position.

3. The method of claim 1, wherein displaying the at least one fluid graphic element is performed when a preset first condition is satisfied, and
wherein the first condition comprises at least one of when a context associated with the electronic device, which coincides with a preset context, is detected; when an event requiring notification to a user occurs, when the electronic device is positioned in a preset area or place; when the electronic device enters a lock mode; when a preset time elapses; when the electronic device operates according to a preset operation pattern; when a user's biometric information matches a preset state; when an attribute value indicating a current state of the electronic device falls within a preset threshold range, and when the current state of the electronic device matches a preset state.

4. The method of claim 1, wherein displaying the at least one fluid graphic element comprises:
generating the at least one fluid graphic element in response to a first input; and
gradually increasing a size of the generated at least one fluid graphic element in response to the first input.

5. The method of claim 1, further comprising:
displaying a boundary fluid graphic element that gradually protrudes from a display region boundary of the display toward a central portion of the display and automatically connecting the at least one fluid graphic element with the boundary fluid graphic element, if a distance between an edge of the at least one fluid graphic element and the display region boundary is less than or equal to a preset threshold value.

6. The method of claim 1, wherein performing the preset function of the electronic device comprises:
transforming or moving the at least one fluid graphic element in response to a second input; and
performing the preset function of the electronic device if at least one attribute of the transformed or moved at least one fluid graphic element satisfies a preset condition,
wherein the at least one attribute comprises information associated with size, area, number, arrangement, or position of the transformed or moved at least one fluid graphic element.

7. The method of claim 1, wherein performing the preset function of the electronic device comprises:
unlocking or releasing a use limitation of at least one function of the electronic device.

8. The method of claim 1, wherein performing the preset function of the electronic device comprises:
removing a visual effect applied to at least a portion of a screen of the display, and
wherein the visual effect comprises at least one of a blur effect for blurring the at least a portion of the screen of the display, a dimming effect for dimming the at least a portion of the screen of the display, a masking effect for displaying a preset image on the at least a portion of the screen of the display, and a transparent effect for transparently displaying the at least a portion of the screen of the display.

9. A non-transitory machine-readable storage medium having recorded thereon a program for executing a method for operating an electronic device, the method comprising the steps of:
displaying at least one fluid graphic element on a display of an electronic device;
determining whether a preset second condition associated with the at least one fluid graphic element is satisfied; and
performing a preset function of the electronic device if the second condition is satisfied.

10. An electronic device comprising:
a display configured to display a screen; and
a processor configured to display at least one fluid graphic element on the display, to determine whether a preset second condition associated with the at least one fluid graphic element is satisfied, and to perform a preset function of the electronic device if the processor determines that the second condition is satisfied.

11. The electronic device of claim 10, wherein the second condition comprises at least one of when a second input is detected; when a context associated with the at least one fluid graphic element, which coincides with a preset context, is detected; when the at least one fluid graphic element is positioned at a preset screen region on the display; when a preset time elapses from generation of the at least one fluid graphic element; when the at least one fluid graphic element moves according to a preset moving pattern; when a current attribute value of the at least one fluid graphic element falls within a preset threshold range; and when a current position of the at least one fluid graphic element coincides with a preset position.

12. The electronic device of claim 10, wherein the at least one fluid graphic element is displayed on a locked screen displayed on the display.

13. The electronic device of claim 10, wherein the processor is configured to display the at least one fluid graphic element if a preset first condition is satisfied, and
wherein the first condition comprises at least one of when a context associated with the electronic device, which coincides with a preset context, is detected; when an event requiring notification to a user occurs; when the electronic device is positioned in a preset area or place; when the electronic device enters a lock mode; when a preset time elapses; when the electronic device operates according to a preset operation pattern; when a user's biometric information matches a preset state; when an attribute value indicating a current state of the electronic device falls within a preset threshold range; and when the current state of the electronic device matches a preset state.

14. The electronic device of claim 10, wherein the processor is configured to generate the at least one fluid graphic element in response to a first input and to gradually increase a size of the generated at least one fluid graphic element in response to the first input.

15. The electronic device of claim 10, wherein the processor is configured to display a boundary fluid graphic element that gradually protrudes from a display region boundary of the display toward a central portion of the display and automatically connect the at least one fluid graphic element with the boundary fluid graphic element, if a distance between an edge of the at least one fluid graphic element and the display region boundary is less than or equal to a preset threshold value.

16. The electronic device of claim 10, wherein the processor is configured to generate the at least one fluid graphic element in response to a first input, and
the first input comprises a touch input or a hovering input on the display, and
the second condition comprises, when a second input associated with the at least one fluid graphic element is detected, and the second input comprises a swipe input or a drag input continuing from the first input on the display.

17. The electronic device of claim 10, wherein the processor is configured to transform or move the at least one fluid graphic element in response to a second input, and to perform the preset function of the electronic device if at least one attribute of the transformed or moved at least one fluid graphic element satisfies a preset condition, and the at least one attribute comprises information associated with size, area, number, arrangement, or position of the transformed or moved at least one fluid graphic element.

18. The electronic device of claim 10, wherein the processor is configured to unlock or release a use limitation of at least one function of the electronic device, if the processor determines that the second condition is satisfied.

19. The electronic device of claim 10, wherein the processor is configured to remove a visual effect applied to at least a portion of a screen of the display, and wherein the visual effect comprises at least one of a blurring effect for blurring the at least a portion of the screen of the display, a dimming effect for dimming the at least a portion of the screen of the display, a masking effect for displaying a preset image on the at least a portion of the screen of the display, and a transparent effect for transparently displaying the at least a portion of the screen of the display.

20. The electronic device of claim 10, wherein the processor is configured to detect inclination information of the electronic device and to move the at least one fluid graphic element based on the inclination information.
